(19) United States
(12) Patent Application Publication
(10) Pub. No.: US 2025/0306517 A1
(43) Pub. Date: Oct. 2, 2025

(54) POST-PROCESSING DEVICE AND IMAGE FORMING SYSTEM USING POST-PROCESSING DEVICE

(71) Applicant: FUJIFILM Business Innovation Corp., Tokyo (JP)

(72) Inventors: Motoharu NAKAO, Kanagawa (JP); Hina SAITO, Kanagawa (JP); Toru INOUE, Kanagawa (JP); Yasutaka GOTOH, Kanagawa (JP); Sodai HIGUCHI, Kanagawa (JP)

(73) Assignee: FUJIFILM Business Innovation Corp., Tokyo (JP)

(21) Appl. No.: 18/820,244

(22) Filed: Aug. 29, 2024

(30) Foreign Application Priority Data
Mar. 28, 2024 (JP) 2024-054830

(51) Int. Cl. G03G 15/00; G03G 15/20

(52) U.S. Cl. CPC G03G 15/6573; G03G 15/2064; G03G 15/607

(57) ABSTRACT

A post-processing device includes a transport section that transports a medium holding an image formed using an imaging material and wax and having passed through a fixing section that performs heating and pressurization to fix the image on the medium, at a predetermined transport velocity by nipping the medium; and a rubbing section that is located upstream or downstream of the transport section in a transport direction of the medium and that rubs, in a case in which the medium transported by the transport section passes through the rubbing section, a surface of the medium such that a layer thickness of the wax held on the surface of the medium after passage is equal to or less than 0.15 μm.

### CROSS-REFERENCE TO RELATED APPLICATIONS

This application is based on and claims priority under 35 USC 119 from Japanese Patent Application No. 2024-054830 filed Mar. 28, 2024.

### BACKGROUND

### (i) Technical Field

The present invention relates to a post-processing device and an image forming system using the post-processing device.

### (ii) Related Art

In the related art, for example, an image forming system and a post-processing device disclosed in JP2002-91205A (Mode for Carrying Out the Invention and FIG. 6), JP2023-87297A (Mode for Carrying Out the Invention and FIG. 10), and JP2005-266079A (Best Mode for Carrying Out the Invention and FIG. 2) have already been known as an image forming system using a toner containing wax or a post-processing device used in the image forming system.

JP2002-91205A (Mode for Carrying Out the Invention and FIG. 6) discloses an image forming device including a cleaning section that cleans a waste material including at least a wax component on a surface of a recording medium after fixing and before being discharged outside a device.

JP2023-87297A (Mode for Carrying Out the Invention and FIG. 10) discloses an image forming system including a fixing unit that fixes an image formed on a recording medium on the recording medium, a reading unit that reads the fixed image, a rubbing unit that can rub the image fixed on the recording medium, and a control unit that reads the image, which is rubbed by the rubbing unit, with the reading unit to evaluate a fixing state of a toner.

JP2005-266079A (Best Mode for Carrying Out the Invention and FIG. 2) discloses a wax removing device that removes wax, which is contained in a toner image heat-fixed by a fixer, on a surface of a recording medium by bringing a blade into contact with the surface of the recording medium having a temperature equal to or higher than a melting point of the wax and lower than a melting point of a toner material.

### SUMMARY

Aspects of non-limiting embodiments of the present disclosure relate to a post-processing device that smoothens a medium by rubbing wax on the medium while the medium is being transported and that makes the wax on the medium less visible, and an image forming system using the post-processing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a post-processing device including a transport section that transports a medium holding an image formed using an imaging material and wax and having passed through a fixing section that performs heating and pressurization to fix the image on the medium, at a predetermined transport velocity by nipping the medium; and a rubbing section that is located upstream or downstream of the transport section in a transport direction of the medium and that rubs, in a case in which the medium transported by the transport section passes through the rubbing section, a surface of the medium such that a layer thickness of the wax held on the surface of the medium after passage is equal to or less than 0.15 μm.

### BRIEF DESCRIPTION OF THE DRAWINGS

Exemplary embodiment(s) of the present invention will be described in detail based on the following figures, wherein:

FIG. 1A is an explanatory diagram showing an outline of an exemplary embodiment of an image forming system including a post-processing device to which the present invention is applied, FIG. 1B is an explanatory diagram showing a typical aspect of the post-processing device shown in FIG. 1A, and FIG. 1C is an explanatory diagram showing another typical aspect of the post-processing device shown in FIG. 1A;

FIG. 2A is an explanatory diagram showing a range of post-processing on a medium using a rubbing section of the post-processing device in the aspect shown in FIG. 1B, FIG. 2B is an explanatory diagram showing a range of post-processing on the medium using the rubbing section of the post-processing device in the aspect shown in FIG. 1C, and FIG. 2C is an explanatory diagram schematically showing a change before and after the wax held on the medium passes through the post-processing device;

FIG. 3 is an explanatory diagram showing an overall configuration of an image forming system according to Exemplary Embodiment 1;

FIG. 4A is an explanatory diagram showing a configuration example of a fixing device used in the image forming system of FIG. 3, FIG. 4B is an explanatory diagram showing a state in which a medium holding an unfixed image formed using a toner enters the fixing device, and FIG. 4C is an explanatory diagram showing a state in which wax on a surface of the toner is transferred to a heating roll that is a fixing member for heating, in a case in which the medium has passed through the fixing device;

FIG. 5A is an explanatory diagram showing a state in which the wax that slips through a cleaning mechanism in the wax transferred to the heating roll is transferred to a side of a pressure roll that is a fixing member for pressurization, FIG. 5B is an explanatory diagram showing a state in which the wax is transferred from the heating roll and the pressure roll that are the fixing members to a front surface and a back surface of the medium in a case in which the subsequent medium passes through the fixing device, and FIG. 5C is an explanatory diagram schematically showing a state in which the wax transferred to the surface of the medium is solidified;

FIG. 6 is an explanatory diagram showing a major part of a post-processing device according to Exemplary Embodiment 1;

FIG. 7 is an explanatory diagram showing a configuration example of a transport roll and a rubbing roll of the post-processing device according to Exemplary Embodiment 1;

FIG. 8A is an explanatory diagram showing a support structure example of the transport roll, and FIG. 8B is an explanatory diagram showing a retract mechanism example shown in FIG. 8A;

FIG. 9A is an explanatory diagram showing a support structure example of the rubbing roll, FIG. 9B is an explanatory diagram showing an example of a nip release mechanism shown in FIG. 9A, FIG. 9C is a view taken from a direction of an arrow C in FIG. 9B, and FIG. 9D is an explanatory diagram showing a configuration example of application of a contact pressure in a case of contact of the rubbing roll;

FIGS. 10A to 10E are explanatory diagrams showing a process of a post-processing operation on the medium using the post-processing device according to Exemplary Embodiment 1;

FIG. 11A is an explanatory diagram schematically showing a change state of the wax held by the medium before and after passing through the post-processing device according to Exemplary Embodiment 1, FIG. 11B is a plan explanatory diagram of FIG. 11A seen from above, and FIG. 11C is an explanatory diagram schematically showing a change state of wax held by a medium before and after passing through a post-processing device according to Comparative Example 1;

FIG. 12 is an explanatory diagram showing a major part of a post-processing device according to Exemplary Embodiment 2;

FIG. 13 is an explanatory diagram showing a configuration example of a transport roll and a rubbing roll of the post-processing device according to Exemplary Embodiment 2;

FIGS. 14A to 14E are explanatory diagrams showing a process of a post-processing operation on a medium using the post-processing device according to Exemplary Embodiment 2;

FIG. 15 is an explanatory diagram showing a drive control system of a post-processing device according to Exemplary Embodiment 3;

FIG. 16 is an explanatory diagram showing a configuration example of a transport roll and a rubbing roll of the post-processing device according to Exemplary Embodiment 3;

FIG. 17 is a flowchart showing a process of control processing of the post-processing device according to Exemplary Embodiment 3;

FIG. 18A is an explanatory diagram schematically showing a first mode of the post-processing device according to Exemplary Embodiment 3, FIG. 18B is an explanatory diagram schematically showing a second mode of the post-processing device, and FIG. 18C is an explanatory diagram schematically showing a third mode of the post-processing device;

FIGS. 19A to 19E are explanatory diagrams showing a process of a post-processing operation on the medium using the post-processing device in which the transport roll is disposed closer to a second rubbing roll than to a first rubbing roll (disposition example in which L1>L2);

FIGS. 20A to 20E are explanatory diagrams showing a process of a post-processing operation on the medium using the post-processing device in which the transport roll is disposed closer to the first rubbing roll than to the second rubbing roll (disposition example in which L2>L1);

FIG. 21A is an explanatory diagram showing ranges of post-processing using the first rubbing roll and the second rubbing roll in the disposition example in which L1>L2 (FIGS. 19A to 19E), and FIG. 21B is an explanatory diagram showing ranges of post-processing using the first rubbing roll and the second rubbing roll in the disposition example in which L2>L1 (FIGS. 20A to 20E);

FIG. 22 is an explanatory diagram showing a major part of a post-processing device according to Exemplary Embodiment 4;

FIG. 23A is an explanatory diagram showing a state in which a medium that requires wax post-processing passes through the post-processing device, and FIG. 23B is an explanatory diagram showing a state in which a medium that does not require the wax post-processing passes through the post-processing device;

FIG. 24 is an explanatory diagram showing a major part of a post-processing device according to Exemplary Embodiment 5;

FIG. 25A is an explanatory diagram showing an example of a microscope photograph obtained by imaging a surface of a medium before post-processing using a post-processing device according to Example 1, FIG. 25B is an explanatory diagram schematically showing a state of wax adhering on the surface of the medium shown in FIG. 25A, FIG. 25C is an explanatory diagram showing an example of a microscope photograph obtained by imaging a surface of the medium after the post-processing using the post-processing device according to Example 1, and FIG. 25D is an explanatory diagram schematically showing a state of the wax adhering on the surface of the medium shown in FIG. 25C; and

FIG. 26 is a graph showing a relationship between a thickness of a thin film-like layer after post-processing of wax adhering to a medium and visibility of the wax in evaluating performance of the post-processing device according to Example 2.

### DETAILED DESCRIPTION

### ⊚ Outline of Exemplary Embodiment

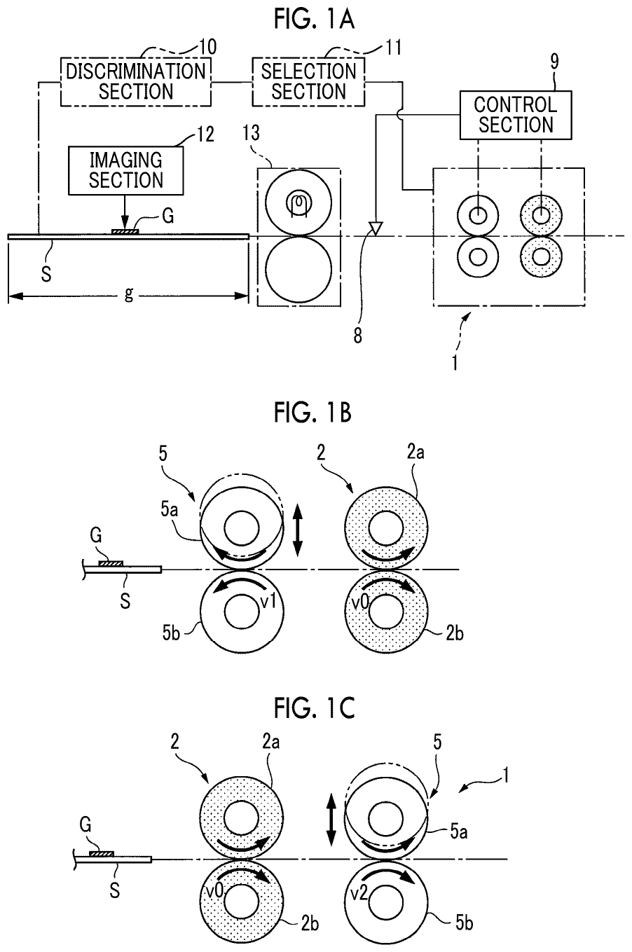

FIG. 1A shows an outline of an exemplary embodiment of an image forming system to which the present invention is applied.

In FIG. 1A, the image forming system includes an imaging section 12 that holds an image G formed using an imaging material containing wax on a medium S, a fixing section 13 that performs heating and pressurization to fix the image formed by the imaging section 12 on the medium, and a post-processing device 1 that performs post-processing on the medium S that has passed through the fixing section 13.

In the present example, as shown in FIG. 1B or 1C, the post-processing device 1 includes a transport section 2 that transports the medium S holding the image G formed using the imaging material and the wax and having passed through the fixing section 13 that performs heating and pressurization to fix the image G on the medium S, at a predetermined transport velocity v0 by nipping the medium S, and a rubbing section 5 that is located upstream or downstream of the transport section 2 in a transport direction of the medium S and that rubs, in a case in which the medium S transported by the transport section 2 passes through the rubbing section 5, a surface of the medium S such that a layer thickness of the wax held on the surface of the medium S after passage is equal to or less than 0.15 μm.

In such technical means, the medium S is not limited to a sheet-like medium cut into a predetermined size, and also includes a continuous medium such as a roll-like medium. In addition, the imaging section 12 need only form the image G formed using the imaging material (for example, a toner) containing the wax and hold the image G on the medium S. Typical examples thereof include an electrophotographic method and an electrostatic recording method, but the present invention is not limited thereto. Here, the reason why the wax is contained in the imaging material is to ensure the mold releasability between the image G and a fixing member during the fixing using the heating and pressurization of the fixing section 13.

In addition, the fixing section 13 may be appropriately selected as long as a fixing method using the heating and pressurization. Typical examples thereof include an aspect in which a fixing member for heating and a fixing member for pressurization are disposed in a pressurized manner, and the medium S passes through a contact region between the fixing member for heating and the fixing member for pressurization. In this case, the fixing member may be appropriately selected from a roll-like fixing member, a belt-like fixing member, or the like. As a heating method of the fixing member for heating, a heating source may be incorporated into the fixing member, or an aspect may be adopted in which the heating is performed outside the fixing member. Further, a cleaning element for cleaning the wax, paper dust, and the like transferred to the fixing member may be additionally provided in the fixing member for heating. Further, a heating source or a cleaning element may be added to the fixing member for pressurization as necessary.

Further, the post-processing device 1 is incorporated into, for example, an image forming unit in which the imaging section 12 and the fixing section 13 are mounted. However, the present invention is not limited to this aspect, and the post-processing device 1 may be configured as an independent unit separate from the image forming unit. In this case, the post-processing device 1 may be installed parallel with the image forming unit to construct the image forming system. Alternatively, the post-processing device may be installed separately from the image forming unit and used to perform the post-processing on the medium S that is once output from the image forming unit.

In the present example, in order for the medium S to pass through the post-processing device 1, an element for feeding the medium S and an element for taking out the medium S are provided before and after a transport path of the medium S in the post-processing device 1. The transport section 2 may be appropriately selected as long as the transport section 2 transports the medium S at the predetermined transport velocity v0 by nipping the medium S. The transport velocity v0 is selected in consideration of a feeding velocity of the medium S fed to the post-processing device 1 or a taking-out velocity of the medium S taken out from the post-processing device 1. As the transport section 2, a plurality of transport members that transport the medium S by nipping the medium S need only be provided.

In the present example, the rubbing section 5 is located upstream or downstream of the transport section 2 in the transport direction of the medium S and is required to rub the surface of the medium S. The meaning of “surface of the medium S” is not limited to the front surface of the medium S and also includes the back surface. Therefore, the rubbing section 5 typically rubs both the front and back surfaces of the medium S as rubbing targets, but also includes a configuration in which a surface of any one of the front surface or the back surface of the medium S is rubbed as the rubbing target.

As the configuration example of the rubbing section 5, as long as the rubbing section 5 has an action of coming into contact with the medium S and rubbing the surface of the medium S, the rubbing section 5 is not limited to the movable aspect and may be fixedly installed.

Further, in the rubbing operation using the rubbing section 5, it is required to rub the surface of the medium S such that a layer thickness tr after the wax held on the surface of the medium S has passed through is equal to or less than 0.15 μm in a case in which the medium S is transported by the transport section 2.

A boundary value 0.15 μm of the layer thickness tr of the wax may be appropriately selected as long as the value is equal to or less than a value necessary to make the wax on the medium S less visible.

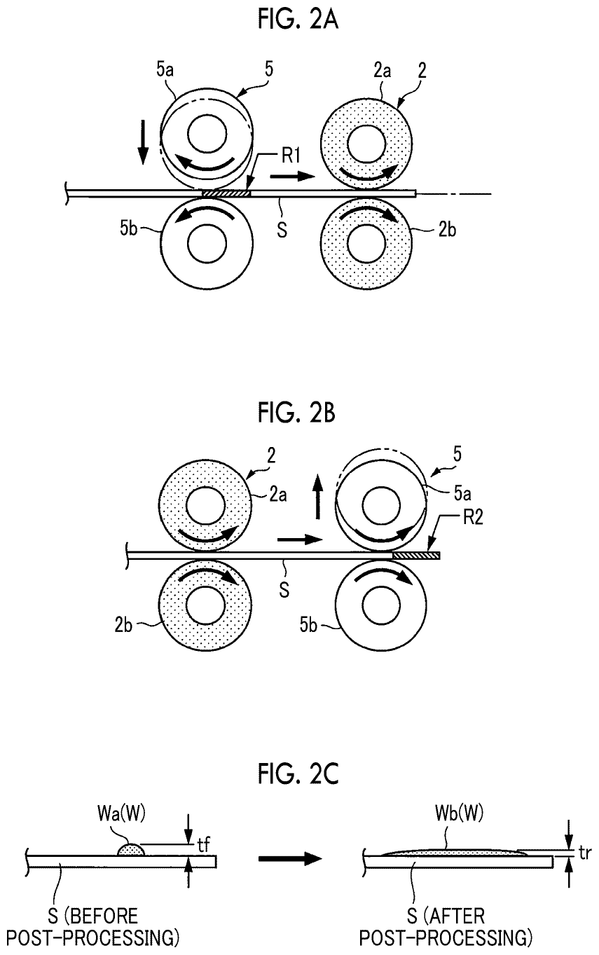

Specifically, in a case in which the wax is transferred to the surface of the medium S that has passed through the fixing section 13, as shown in FIG. 2C, wax W is deformed to be rounded by the surface tension in a process of being cooled and solidified, and a granular mass (lump) Wa is likely to be formed. In this case, in a case in which, for example, a transparent film having a smooth surface is used as the medium S, light is scattered by a portion of the granular mass Wa, and thus the granular mass Wa is whitened and visualized.

In the present example, the post-processing device 1 rubs the surface of the medium S via the rubbing section 5. Therefore, it is possible to smoothen the wax W, which has been the granular mass Wa, to form a thin film-like layer Wb. Here, in a case in which the layer thickness tr of the thin film-like layer Wb is selected to an appropriate level, the visualization phenomenon of the wax W due to the scattering of the transmitted light or the reflected light on the medium S is reduced, and the wax on the medium S is less visible.

Next, a typical aspect or a desired aspect of the post-processing device 1 according to the present exemplary embodiment will be described.

### Disposition Example 1 of Rubbing Section

First, examples of a typical aspect of the rubbing section 5 include, as shown in FIG. 1B, an aspect in which the rubbing section 5 is located upstream of the transport section 2 in the transport direction of the medium S and rubs the surface of the medium S in a direction opposite to the transport direction of the medium S at a velocity v1 different from the transport velocity v0. In this case, the medium S is transported in a state of being pulled in the transport direction between the rubbing section 5 and the transport section 2.

Here, in order to rub the surface of the medium S via the rubbing section 5 in the direction opposite to the transport direction of the medium S in a case in which the medium S is transported by the transport section 2 at the transport velocity v0, the rubbing section 5 need only behave as follows. Specifically, the rubbing section 5 performs any behavior of (i) moving in the direction opposite to the transport direction of the medium S, (ii) maintaining a stop state, or (iii) moving in the direction identical to the transport direction of the medium S at a velocity lower than the transport velocity v0 of the medium S.

In this regards, in a case in which it is assumed that the rubbing section 5 moves in the direction identical to the transport direction of the medium S at the velocity identical to the transport velocity v0 of the medium S, a relative velocity between the rubbing section 5 and the medium S is identical, and the rubbing phenomenon does not occur between the rubbing section 5 and the medium S. In addition, in a case in which it is assumed that the rubbing section 5 moves in the direction identical to the transport direction of the medium S at the velocity higher than the transport velocity v0 of the medium S, there is a high possibility that the medium S is delivered at the velocity higher than the transport velocity v0 via the rubbing section 5. Therefore, the transportability of the medium S may be impaired between the rubbing section 5 and the transport section 2.

### Action of Disposition Example 1 of Rubbing Section

In the present example, as shown in FIG. 2A, the medium S passes through the rubbing section 5 and then reaches the transport section 2. During this period, the rubbing operation using the rubbing section 5 is not yet performed.

Next, in a case in which a leading end of the medium S in the transport direction passes through the transport section 2, the transport section 2 transports the medium S at the transport velocity v0 by nipping the medium S. In this state, the rubbing section 5 starts the rubbing operation and rubs the surface of the medium S in the direction opposite to the transport direction of the medium S at the velocity v1 different from the transport velocity v0. Therefore, after the leading end of the medium S in the transport direction has passed through the transport section 2, the rubbing operation using the rubbing section 5 is performed.

Then, a rubbing region R1 of the rubbing section 5 is started to be formed from the middle in the transport direction of the medium S that passes through the rubbing section 5, and is continuously formed until the trailing end of the medium S in the transport direction passes through the rubbing section 5.

### Disposition Example 2 of Rubbing Section

Other examples of the typical aspect of the rubbing section 5 include, as shown in FIG. 1C, an aspect in which the rubbing section 5 is located downstream of the transport section 2 in the transport direction of the medium S and rubs the surface of the medium S in a direction identical to the transport direction of the medium S at a velocity v2 higher than the transport velocity v0. In this case, the medium S is transported in a state of being pulled in the transport direction between the transport section 2 and the rubbing section 5.

In a case in which it is assumed that the rubbing section 5 moves in the direction identical to the transport direction of the medium S at the velocity identical to the transport velocity v0 of the medium S, a relative velocity between the rubbing section 5 and the medium S is identical, and the rubbing phenomenon does not occur between the rubbing section 5 and the medium S. In addition, it is assumed that the rubbing section 5 moves in the direction identical to the transport direction of the medium S at the velocity lower than the transport velocity v0 of the medium S. In this case, the transport velocity v0 of the medium S is reduced at a stage in which the medium S passes through the rubbing section 5, and there is a high possibility that the medium S is buckled and deformed in the transport direction between the transport section 2 and the rubbing section 5. Further, it is assumed that the rubbing section 5 moves in the direction opposite to the transport direction of the medium S. In this case, the transport velocity v0 of the medium S is further reduced at the stage in which the medium S passes through the rubbing section 5, and the possibility that the medium S is buckled and deformed between the transport section 2 and the rubbing section 5 is further increased. Therefore, the transportability of the medium S may be impaired between the transport section 2 and the rubbing section 5.

### Action of Disposition Example 2 of Rubbing Section

In the present example, before the leading end of the medium S in the transport direction reaches the rubbing section 5, as shown in FIG. 2B, the rubbing section 5 is in a standby state of being capable of performing the rubbing operation. Then, in a case in which the leading end of the medium S in the transport direction reaches the rubbing section 5, the rubbing section 5 starts the rubbing operation and rubs the surface of the medium S in the direction identical to the transport direction of the medium S at the velocity v2 higher than the transport velocity v0. Therefore, after the leading end of the medium S in the transport direction has passed through the rubbing section 5, the rubbing operation using the rubbing section 5 is performed.

Then, a rubbing region R2 of the rubbing section 5 is started to be formed from the leading end of the medium S in the transport direction and is continuously formed until immediately before the trailing end of the medium S in the transport direction passes through the transport section 2. Here, the rubbing section 5 stops the rubbing operation immediately before the trailing end of the medium S in the transport direction passes through the transport section 2. This is because, in a case in which the rubbing operation using the rubbing section 5 is continued at a stage in which the leading end of the medium S in the transport direction passes through the transport section 2, the transportability of the medium S is impaired.

### Combination of Disposition Examples 1 and 2 of Rubbing Section

A combination of Disposition Examples 1 and 2 of the rubbing section 5 can also be used.

In this case, the rubbing region R1 of the rubbing section 5 according to Disposition Example 1 is formed in a range from the middle of the medium S in the transport direction to the trailing end in the transport direction as shown in FIG. 2A. On the other hand, the rubbing region R2 of the rubbing section 5 according to Disposition Example 2 is formed in a range from the leading end of the medium S in the transport direction to the middle of the medium S in the transport direction. In this case, in a case in which R1+R2 is equal to or larger than a transport direction length g of the medium S, in a combination aspect between the rubbing section 5 according to Disposition Example 1 and the rubbing section 5 according to Disposition Example 2, the rubbing operation is performed on the entire region of the surface of the medium S.

As shown in FIG. 1B or 1C, examples of typical aspects of the transport section 2 and the rubbing section 5 include the following aspect. As the transport section 2, there is an aspect in which the transport section 2 consists of a plurality of rotating bodies 2a and 2b that are disposed to face each other with respect to the medium S. There is an aspect in which the rubbing section 5 consists of a plurality of rotating bodies 5a and 5b that are disposed to face each other with respect to the medium S and that are capable of coming into contact with and separating from each other between a contact position and a non-contact position.

A roll-like member is a typical example of the rotating body referred to herein, but a belt-like member stretched by a plurality of tension members is also included.

In the present example, examples of desired aspects of the transport section 2 and the rubbing section 5 include a magnitude relationship of a frictional force with the medium S. In this case, it is sufficient to consider that the rubbing operation using the rubbing section 5 is realized under the condition that the transport velocity v0 of the medium S using the transport section 2 is maintained. In view of this point, for example, an aspect is preferable in which a frictional force between the plurality of rotating bodies 2a and 2b constituting the transport section 2 and the medium S is larger than a frictional force between the plurality of rotating bodies 5a and 5b constituting the rubbing section 5 and the medium S.

In addition, examples of a desired aspect for setting the magnitude relationship of the frictional force include an aspect in which the frictional force can be easily adjusted. In this case, it is sufficient to take into consideration that the frictional force depends on a reaction force acting on the medium S from a vertical direction and a kinetic friction coefficient between the contact portions. That is, since the kinetic friction coefficient is uniquely determined by a material between the contact portions, it is sufficient to make it possible to adjust the reaction force. In view of this point, for example, it is preferable that the transport section 2 and the rubbing section 5 include an adjustment portion that adjusts contact pressures of the plurality of rotating bodies 2a and 2b and the plurality of rotating bodies 5a and 5b.

In Disposition Examples 1 and 2 (see FIGS. 1B and 1C), as shown in FIG. 1A, for example, an aspect is preferable in which the rubbing operation is performed by the rubbing section 5 based on a transport position of the medium S. In order to realize this aspect, the position detection section 8 that detects the transport position of the medium S, and the control section 9 that controls the rubbing operation using the rubbing section 5 based on the positional information from the position detection section 8 need only be provided.

Here, in a case of taking Disposition Example 1 (see FIG. 1B) as an example, examples of the aspect in which the rubbing operation on the backward region of the medium S in the transport direction is performed well include the following aspect. In this case, the control section 9 need only dispose, immediately after the leading end of the medium S in the transport direction has entered the transport section 2, the rubbing section 5 at the contact position in contact with the surface of the medium S to start the rubbing operation using the rubbing section 5.

In addition, examples of an aspect in which the wax post-processing on a subsequent medium Sr is smoothly performed include the following aspect. In this case, the control section 9 need only dispose, immediately after the trailing end of the medium S in the transport direction has passed through the rubbing section 5, the rubbing section 5 at the non-contact position separated from the contact position in contact with the surface of the medium S to stop the rubbing operation using the rubbing section 5.

Further, in a case of taking Disposition Example 2 (see FIG. 1C) as an example, examples of the aspect in which the rubbing operation on the forward region of the medium S in the transport direction is performed well include the following aspect. In this case, the control section 9 need only dispose, before the leading end of the medium S in the transport direction reaches the rubbing section 5, the rubbing section 5 at the contact position in contact with the surface of the medium S to start the rubbing operation using the rubbing section 5.

Further, examples of an aspect for eliminating, in advance, a situation in which the transportability of the medium S is impaired by the rubbing section 5 include the following aspect. In this case, the control section 9 need only dispose, immediately before the trailing end of the medium S in the transport direction passes through the transport section 2, the rubbing section 5 at the non-contact position separated from the contact position in contact with the surface of the medium S to stop the rubbing operation using the rubbing section 5.

In addition, examples of an aspect in which the wax post-processing is performed only on the medium S that requires the wax post-processing include the following aspect. In this case, as shown in FIG. 1A, the post-processing device 1 need only include a discrimination section 10 that discriminates whether or not the medium S to be used is a medium of a predetermined first type, and a selection section 11 that performs the rubbing operation using the rubbing section 5 in a case in which the discrimination section 10 discriminates that the medium is the first type.

In the present aspect, examples of a desired aspect as the medium of the first type include an aspect in which the medium is a type in which the wax transferred to the front surface or the back surface is visualized. A typical medium in which the visualization phenomenon is remarkably exhibited is a film medium having a smooth surface.

In addition, examples of a desired aspect for the medium S that does not require the wax post-processing include the following aspect. In this case, it is sufficient that the selection section 11 does not perform the rubbing operation using the rubbing section 5 in a case in which the discrimination section 10 discriminates that the medium is a type other than the first type.

### ⊚ Exemplary Embodiment 1

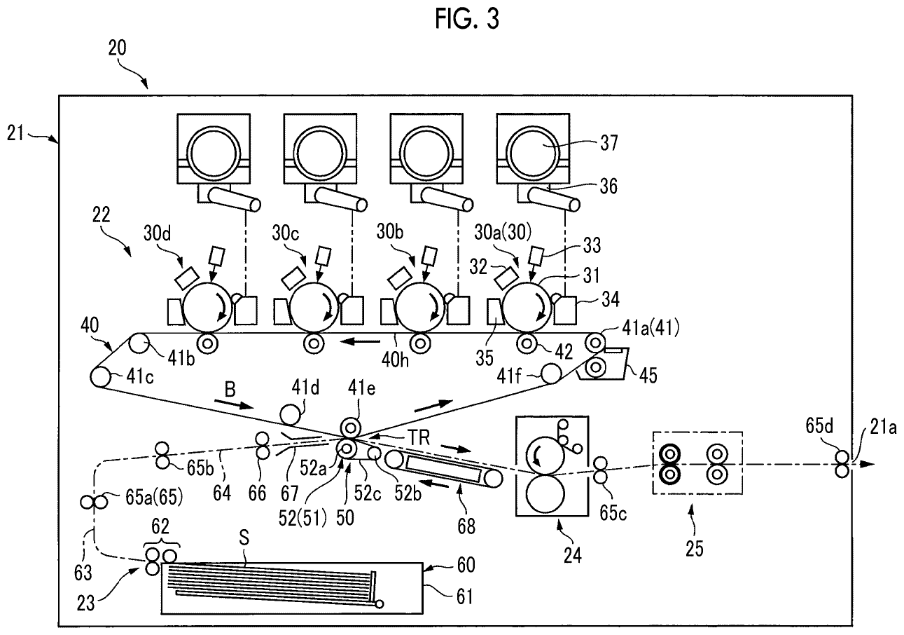

FIG. 3 shows an overall configuration of an image forming system according to Exemplary Embodiment 1.

### Overall Configuration of Image Forming System

In FIG. 3, an image forming system 20 has a unit housing 21 consisting of a required external appearance shape. Major elements such as an imaging engine 22, a medium transport system 23, a fixing device 24, and a post-processing device 25 are mounted in an internal space of the unit housing 21.

### Imaging Engine

In the present example, the imaging engine 22 corresponds to the imaging section 12 shown in FIGS. 1A and 1B.

In FIG. 3, the imaging engine 22 includes a plurality of (four in the present example) image forming portions 30 (specifically, 30a to 30d) that form images of a plurality of (four in the present example) color components, an intermediate transfer body 40 that sequentially performs primary transfer of the images of the respective color components formed by the plurality of image forming portions 30 to hold the images, and transports the images to a position for the transfer to the medium, and a transfer device 50 that performs secondary (batch) transfer of the images of the respective color components held by the intermediate transfer body 40 to the medium.

In the present example, the respective image forming portions 30 (30a to 30d) form the images of the respective color components of yellow (Y), magenta (M), cyan (C), and black (K). The arrangement of the image forming portions 30 may be appropriately changed, and it goes without saying that a portion that forms the image of another color component (white, transparent, spot color of special color component, or the like) may also be included in the plurality of image forming portions 30. In addition, in the present example, the image forming portion 30 is configured to form the images of a plurality of color components, but may form, for example, a monochromatic image of only black (K). Further, in the present example, the imaging engine 22 forms the image on the medium via the intermediate transfer body 40, but the imaging engine 22 may form the image directly on the medium without passing through the intermediate transfer body 40.

### Image Forming Portion

In FIG. 3, each of the image forming portions 30 (30a to 30d) adopts an electrophotographic method. In the present example, each of the image forming portions 30 (30a to 30d) has a photoconductor 31 that rotates in a predetermined direction. Then, devices such as a charger 32, an exposure device 33, a developing device 34, and a cleaning device 35 are disposed in order around the photoconductor 31.

Here, the photoconductor 31 is formed in, for example, a drum shape and has a photosensitive layer serving as an image forming surface and an image holding surface, on a surface thereof. In addition, the charger 32 charges an outer peripheral surface of the photoconductor 31 to a required surface potential. As the charger 32, for example, a non-contact charging method using a corona discharge or a contact charging method using a charging roll is adopted.

Further, the exposure device 33 irradiates the outer peripheral surface of the photoconductor 31 with light in accordance with image information to form an electrostatic latent image for each color component image. As the exposure device 33, a light irradiation device such as a laser scanner or an LED array is used. In the present example, the exposure device 33 is individually provided for each of the image forming portions 30 (30a to 30d), but a part or all of the exposure devices 33 may be commonly used.

In addition, the developing device 34 uses a developer containing each color component toner as an example of the imaging material, and develops each electrostatic latent image on the photoconductor 31 as an image formed using each color component toner. The toner in the developer contains an appropriate amount of wax. This wax is mostly used to ensure the mold releasability between the fixing member of the fixing device 24 and the image on the medium. Further, a toner replenishing mechanism 36 is provided in an upper space portion of the developing device 34 of each image forming portion 30, and is connected to each developing device 34 in communication. A toner cartridge 37 including a container that accommodates a toner for replenishment is attachably and detachably provided in each toner replenishing mechanism 36.

In addition, the cleaning device 35 is provided downstream of a primary transfer portion of the photoconductor 31 to the intermediate transfer body 40 in a rotation direction of the photoconductor 31. The cleaning device 35 cleans the residues such as the toner remaining on the photoconductor 31 after the primary transfer.

In the present example, the electrophotographic method using the photoconductor 31 and the exposure device 33 is adopted, but the present invention is not limited to this, and it goes without saying that the electrostatic recording method using a dielectric and an ion flow recorder may be adopted.

### Intermediate Transfer Body

In the present example, the intermediate transfer body 40 consists of, for example, an endless belt member made of a polyimide resin or the like. The intermediate transfer body 40 is bridged over a plurality of (six in the present example) tension rolls 41 (specifically, 41a to 41f). In the present example, among the plurality of tension rolls 41, for example, the tension roll 41a is used as a driving roll, and the other tension rolls 41b to 41f are used as driven rolls. In the present example, the photoconductors 31 of the image forming portions 30 are arranged at predetermined intervals to face a horizontal portion 40h of the intermediate transfer body 40, which is bridged between the tension rolls 41a and 41b.

On a back surface of the horizontal portion 40h of the intermediate transfer body 40, the primary transfer device 42 is provided to face the photoconductor 31 of each image forming portion 30. Each primary transfer device 42 electrostatically transfers the image formed by each image forming portion 30 to the intermediate transfer body 40. Here, the primary transfer device 42 may be appropriately selected as long as the primary transfer device 42 causes a transfer electric field for attracting the image on the photoconductor 31 to the intermediate transfer body 40 side to act. For example, a transfer member (for example, a transfer roll, a discharge wire for generating a corona discharge, or the like) need only be installed to face the photoconductor 31, and a transfer voltage for primary transfer need only be applied to the transfer member.

Further, an intermediate transfer body cleaning device 45 is provided on an outer peripheral surface of the intermediate transfer body 40, which is bridged over the tension roll 41a. The intermediate transfer body cleaning device 45 cleans the residues such as the toner, paper dust, and the like remaining on the intermediate transfer body 40 after the image is transferred to the medium.

### Transfer Device

In the present example, the transfer device 50 is provided on an outer peripheral surface of the intermediate transfer body 40, which is bridged over the tension roll 41e. The transfer device 50 electrostatically transfers the image held on the intermediate transfer body 40 to the medium. Here, the transfer device 50 may be appropriately selected as long as the transfer device 50 causes a transfer electric field for attracting the image on the intermediate transfer body to the medium side to act. For example, the transfer member 51 may be installed to face the tension roll 41e of the intermediate transfer body 40, and a transfer voltage for secondary transfer need only be applied to the transfer member 51 or the tension roll 41e to form a transfer electric field for secondary (batch) transfer between the transfer member 51 and the tension roll 41e. In the present example, a transfer belt module 52 is adopted as the transfer member 51. The transfer belt module 52 has an aspect in which a transfer belt 52c is bridged between a transfer roll 52a and a peeling roll 52b. In the present example, a transfer electric field is formed between the transfer roll 52a and the tension roll 41e, and an action region of the transfer electric field acts as a transfer region TR. The medium S receives the image transfer operation in the transfer region TR, passes through the transfer region TR, is guided along the transfer belt 52c, and is peeled off by the peeling roll 52b.

The transfer member 51 is not limited to the transfer belt module 52, and an aspect in which only the transfer roll is used or a discharge wire using a corona discharge or the like may be appropriately selected.

### Medium Transport System

In the present example, the medium transport system 23 includes a medium supply device 60 that supplies the medium S. In the present example, a sheet-like medium S cut to a predetermined size is used. This medium supply device 60 accommodates the medium S in an accommodation container 61 and sends out the medium S one by one by a feeder 62. In the present example, one accommodation container 61 is provided, but a plurality of accommodation containers 61 may be provided.

In addition, a vertical transport path 63 that transports the medium S supplied from the medium supply device 60 in a substantially vertical direction is provided in the unit housing 21. A horizontal transport path 64 that transports the medium S in a substantially horizontal direction is provided on an upper side of the vertical transport path 63. Here, the horizontal transport path 64 extends to a discharge port 21a open in a side wall of the unit housing 21. In addition, a discharge receiver (not shown) that receives the discharged medium S is provided outside the discharge port 21a of the unit housing 21. An appropriate number of transport rolls 65 (specifically, 65a to 65d) are provided in the vertical transport path 63 and the horizontal transport path 64. The transport roll 65d provided immediately before the discharge port 21a functions as a discharge roll that discharges the medium S to the discharge receiver.

Further, in the horizontal transport path 64, an alignment roll 66 is provided upstream of the transfer region TR of the transfer device 50 in the transport direction of the medium S. The alignment roll 66 aligns the leading end of the medium S supplied from the medium supply device 60 and then sends out the medium S toward the transfer region TR at an appropriate timing. Further, a guide member 67 that guides the medium S toward the transfer region TR is provided between the alignment roll 66 and the transfer region TR.

In addition, in the horizontal transport path 64, a transport belt 68 is provided downstream of the transfer device 50 in the transport direction of the medium S. The transport belt 68 transport the medium S on which the unfixed image is held, by stably holding the medium S in a state of being electrostatically attracted.

Further, in the horizontal transport path 64, the fixing device 24 is provided downstream of the transport belt 68 in the transport direction of the medium S. In the horizontal transport path 64, the post-processing device 25 is provided downstream of the fixing device 24 in the transport direction of the medium S.

In the present example, the medium transport system 23 has the aspect in which only the vertical transport path 63 and the horizontal transport path 64 are provided, but the present invention is not limited to this. For example, a reversible branch transport path (not shown) that branches downward between the fixing device 24 and the post-processing device 25 may be provided in the horizontal transport path 64. In the aspect in which the branch transport path is provided, the medium reversed by the branch transport path may be returned to the vertical transport path 63 again from the horizontal transport path 64 through a return transport path. In this case, it is possible to transfer the image to the back surface of the reversed medium in the transfer region TR. In addition, a branch return transport path that branches from the middle in the branch transport path may be provided, and the reversed medium may be discharged to the discharge receiver outside the unit housing 21.

### Fixing Device

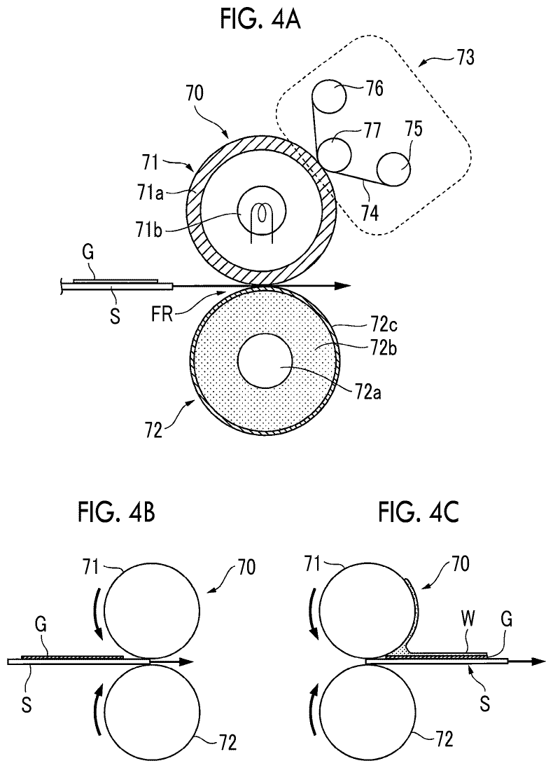

In the present example, as shown in FIG. 4A, the fixing device 24 performs heating and pressurization to fix the image on the medium S. The fixing device 24 includes a heating roll 71 as the fixing member for heating and a pressure roll 72 as the fixing member for pressurization. The heating roll 71 is disposed in contact with an image holding surface side of the medium S and rotates via a drive force from a drive source (not shown). On the other hand, the pressure roll 72 is disposed to face the heating roll 71 in a strongly pressed manner and rotates following the heating roll 71. Therefore, the fixing device 24 allows the image G formed using the toner held on the medium S to pass through a fixing region FR between the heating roll 71 and the pressure roll 72, and performs heating and pressurization to fix the image G.

In the present example, the heating roll 71 is formed in an aspect in which a heater 71b is built in a roll body 71a made of metal having a high thermal conductivity. Here, a heating method of the heating roll 71 is not limited to this, and the roll body 71a may be heated by bringing an external heater (not shown) into contact with an outer peripheral surface of the roll body 71a.

On the other hand, the pressure roll 72 is formed by laminating a heat-resistant elastic layer 72b around a core bar 72a made of metal, and coating a surface of the elastic layer 72b with a protective layer 72c. A heater may be added to the pressure roll 72 as necessary.

In the present example, the medium S is allowed to, in a state of being nipped by the elastic deformation of the pressure roll 72, pass through the fixing region FR between the heating roll 71 and the pressure roll 72 and the image G on the medium S is heated and pressurized.

In the present example, the fixing device 24 has a roll pair configuration, but the present invention is not limited to this, and the fixing device 24 may be appropriately selected, for example, to be configured with a heating belt in which an electromagnetic induction heating method is adopted, instead of the heating roll 71.

### Cleaning Mechanism

In the present exemplary embodiment, the heating roll 71 of the fixing device 24 is provided with a cleaning mechanism 73. The cleaning mechanism 73 mostly reduces a wax component in the toner adhering to the heating roll 71.

Here, the reason why the wax component adheres to the heating roll 71 will be briefly supplemented.

In general, the toner used in the developing device 34 of the image forming portion 30 contains the wax. Therefore, as shown in FIG. 4A, the image G formed using the toner transferred to the medium S contains the wax component. In this state, as shown in FIGS. 4B and 4C, in a case in which the medium S holding the image G passes through the fixing region FR of the fixing device 24, the image G is fixed on the medium S in the fixing region FR by performing heating and pressurization. In this case, a situation occurs in which a part of the wax W on a toner surface is transferred from the image G portion to the heating roll 71 by the heating.

In the present example, as shown in FIG. 4A, the cleaning mechanism 73 adopts a method of pressing and moving the cleaning member in a rubbing manner on the surface of the heating roll 71. Specifically, the cleaning mechanism 73 includes a cleaning web 74, a delivery roll 75, a winding roll 76, and a pressing roll 77. Here, the cleaning web 74 is, for example, an example of a cleaning member consisting of a heat-resistant nonwoven fabric or the like. The delivery roll 75 is an example of a delivery member around which the cleaning web 74 is wound in a state of being braked to be delivered. The winding roll 76 is an example of a winding member around which the used part of the cleaning web 74 is wound to be wound. Further, the pressing roll 77 is an example of a pressing member that presses the cleaning web 74 bridged between the delivery roll 75 and the winding roll 76 against the heating roll 71.

With the cleaning mechanism 73 according to the present example, the cleaning web 74 is pressed and moved in a rubbing manner on the surface of the heating roll 71. In this case, since the cleaning web 74 is made of a heat-resistant nonwoven fabric or the like, the liquefied wax W is absorbed by the capillary phenomenon on the surface of the heating roll 71. In the present example, it is effective to gradually wind the cleaning web 74 in terms of increasing an absorption life of the cleaning web 74.

### Issue of Cleaning Mechanism

The cleaning mechanism 73 according to the present example has the following issue.

In the cleaning mechanism 73 according to the present example, the cleaning web 74 has a structure in which the cleaning web 74 comes into contact with the rotating heating roll 71 only once in principle. Therefore, there may be a case in which the wax W cannot be sufficiently absorbed due to the capillary phenomenon in a case in which the cleaning web 74 comes into contact with the wax W which is liquefied but still has viscosity only once.

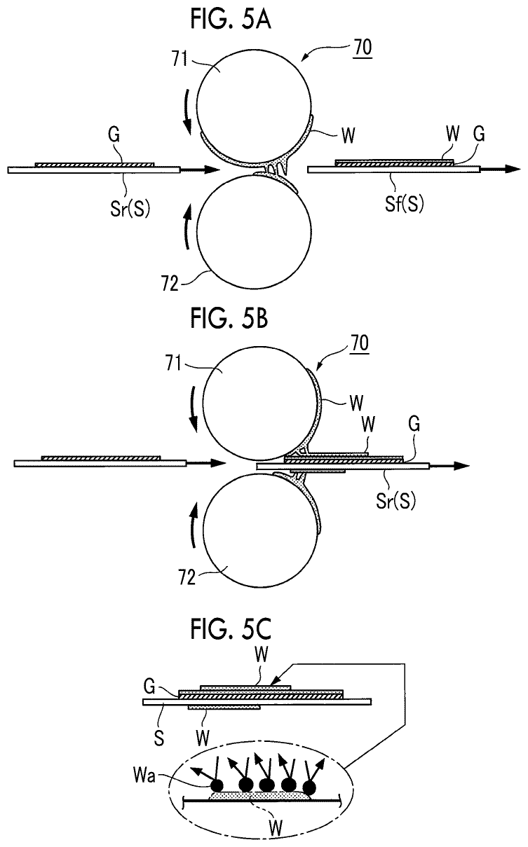

In this case, as shown in FIG. 5A, a situation before a preceding medium Sf exits the fixing region FR of the fixing device 24 and the subsequent medium Sr enters the fixing region FR of the fixing device 24 is assumed. In an inter-image region between the preceding medium Sf and the subsequent medium Sr (region between the media S), the heating roll 71 and the pressure roll 72 are in a state of being in direct contact with each other in the fixing region FR. In this state, a part of the wax W transferred to the heating roll 71 is not cleaned by the cleaning mechanism 73 (see FIG. 4A) and slips. In this case, the wax W is transferred from the heating roll 71 to the pressure roll 72.

Thereafter, as shown in FIG. 5B, in a case in which the subsequent medium Sr passes through the fixing region FR, a situation occurs in which the wax W transferred to the heating roll 71 and the pressure roll 72 is counter-transferred to the front surface and the back surface of the medium S.

Therefore, the wax W may remain on the surface of the medium S even after the fixation using the fixing device 24. In this case, as shown in FIG. 5C, the wax W remaining on the medium S is aggregated in a granular form and solidified along with the cooling of the medium S, and is changed to the granular mass Wa. In this state, for example, in a case in which the medium S is a transparent film medium, the reflected light or the transmitted light to the medium S is scattered by the granular mass Wa, and the wax trace is visualized. In this way, in a case in which the wax trace is visualized, the wax trace is manifested as a contamination or an image defect of the medium S.

In order to eliminate such a situation, for example, it is considered to increase the number of times of contact between the heating roll 71 and the cleaning web 74 of the cleaning mechanism 73. However, this measure requires the rotation of the heating roll 71 to be continued for a long time, and the fixing processing using the fixing device 24 is required to be waited for during the time, so that it cannot be said that this measure is a desired measure.

In the present example, the cleaning mechanism 73 is provided only on the heating roll 71, but it goes without saying that the cleaning mechanism 73 may be provided on the pressure roll 72 side. However, even in a case in which the cleaning mechanism 73 is added to both the heating roll 71 and the pressure roll 72, it is difficult to completely remove the wax W that slips through the cleaning mechanism 73 on the heating roll 71 and the pressure roll 72.

### Post-Processing Device

In the present exemplary embodiment, as shown in FIG. 3, the post-processing device 25 is provided downstream of the fixing device 24 in the transport direction of the medium S, in consideration of a possibility that the wax W remains on the medium S that has passed through the fixing device 24.

In the present example, the post-processing device 25 performs the post-processing of changing the wax remaining on the medium S from a visible state (granular mass) to a less visible state (smoothened state). This is to suppress a light scattering phenomenon caused by the granular mass Wa by spreading and smoothening the granular mass Wa via the rubbing operation.

### Basic Configuration of Post-Processing Device

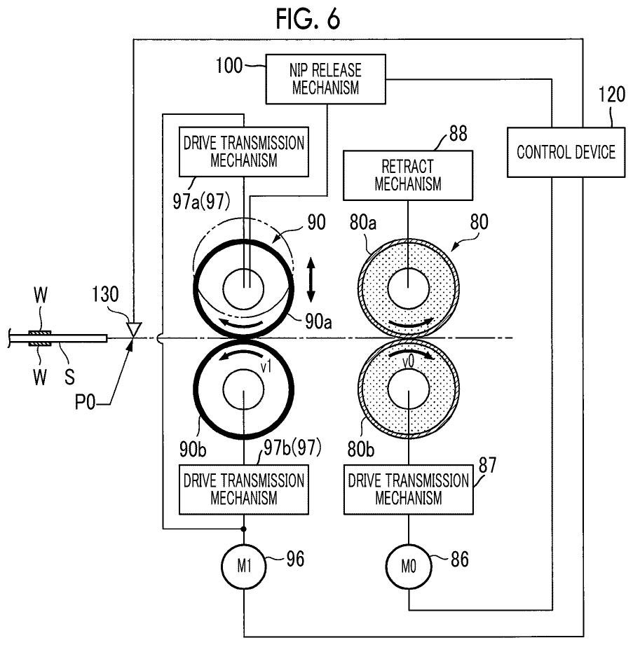

In the present example, as shown in FIG. 6, the post-processing device 25 includes a transport roll 80 as a transport section that transports the medium S that has passed through the fixing device 24 at the predetermined transport velocity v0 by nipping the medium S, the rubbing roll 90 as the rubbing section that is located upstream of the transport roll 80 in the transport direction of the medium S and that rubs the surface of the medium S in the direction opposite to the transport direction of the medium S at the velocity v1 different from the transport velocity v0, and the transport roll 80 and the rubbing roll 90 are appropriately arranged and mounted in a housing (not shown). In the housing (not shown), an inlet opening and an outlet opening for the medium S to pass through are formed.

In the present example, the rubbing roll 90 is configured to rub both the front and back surfaces of the medium S. This is because there is a possibility that the wax W is transferred to both the front and back surfaces of the medium S that has passed through the fixing device 24.

### Transport Roll

### Configuration Example and Drive Method of Transport Roll

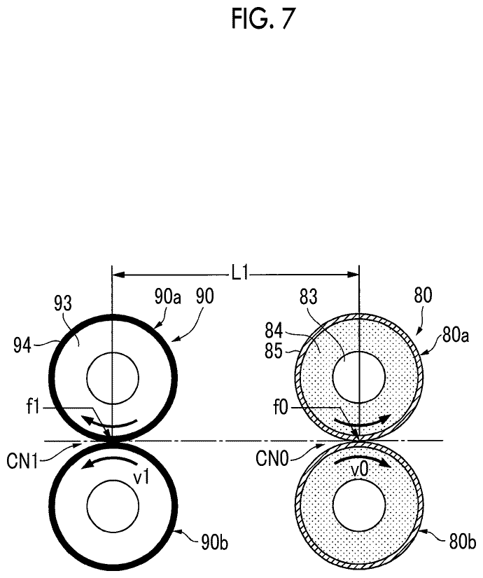

In the present example, as shown in FIGS. 6 and 7, the transport roll 80 consists of a plurality of rotating bodies 80a and 80b that are disposed to face each other with respect to the medium S. The rotating bodies 80a and 80b constituting the transport roll 80 have a structure in which a solid shaft 83 made of metal such as SUS is covered with an elastic layer 84 such as silicone rubber and a mold-releasing layer 85 such as PFA for preventing the wax from adhering is provided on a surface of the elastic layer 84.

In the present example, the plurality of rotating bodies 80a and 80b are disposed in contact with each other, and the medium S is nipped in a contact region CN0 between the rotating bodies 80a and 80b and transported. Here, in the transport roll 80, among the plurality of rotating bodies 80a and 80b, for example, the rotating body 80b located on the lower side is a driving roll, and the rotating body 80a located on the upper side is a driven roll. Then, a drive force from a drive motor 86 is transmitted to the rotating body 80b as a driving roll through a drive transmission mechanism 87 such as a drive transmission gear train.

### Retract Configuration Example of Transport Roll

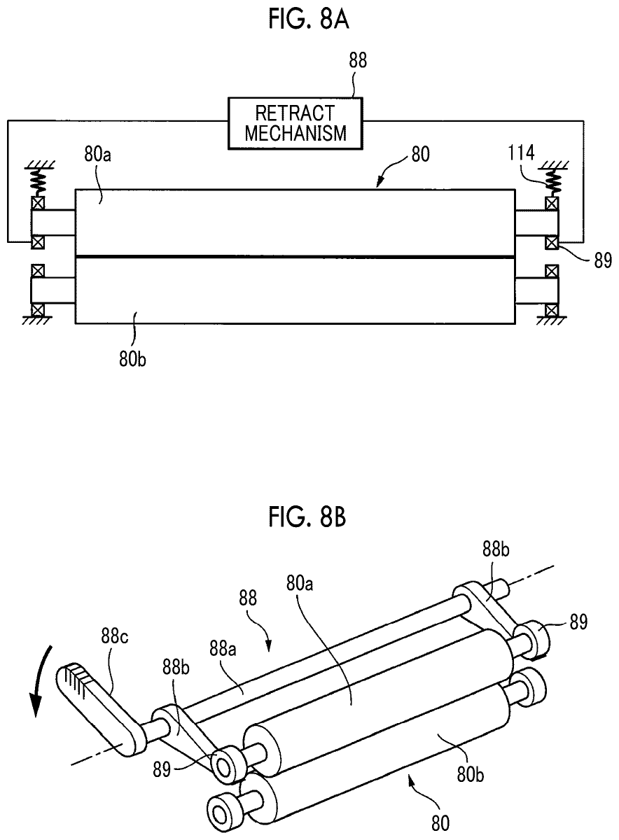

In the present example, as shown in FIGS. 6, 8A, and 8B, a retract mechanism 88 as a retractable retract section is provided in one rotating body 80a of the transport roll 80. The retract mechanism 88 supports both ends of the shaft 83 of one rotating body 80a, and releases a nip state (corresponding to a contact state between the plurality of rotating bodies 80a and 80b) of the transport roll 80, for example, in a case in which the medium S is jammed. In the present example, as shown in FIG. 8B, the retract mechanism 88 has, on both sides of a support shaft 88a that is rotatable, support arms 88b that protrude radially with respect to the support shaft 88a. The support arms 88b support bearings 89 provided at both ends of the shaft 83 of one rotating body 80a from the lower side. In addition, an operation lever 88c that protrudes radially with respect to the support shaft 88a in a direction different from the support arms 88b is provided at one end of the support shaft 88a.

### Setting of Nip Pressure of Transport Roll

As shown in FIG. 8A, biasing springs 114 as biasing sections for adjusting a nip pressure (corresponding to a contact pressure of the contact region CN0 between the plurality of rotating bodies 80a and 80b) of the transport roll 80 are provided at both ends of one rotating body 80a of the transport roll 80. The biasing spring 114 is composed of, for example, a compression coil spring, and can variably set a biasing force by adjusting a compression deformation amount at an adjustment portion (not shown). As a result, the nip pressure of the transport roll 80 is set.

### Use Example of Retract Mechanism

In the present example, the retract mechanism 88 need only be operated, for example, in a case in which the medium S is jammed (medium jam) during the passage of the transport roll 80. Specifically, as shown in FIG. 8B, an operator need only manually push down the operation lever 88c of the retract mechanism 88 and swing the support arms 88b upward about the support shaft 88a. In this case, the rotating body 80a is pushed up by the support arms 88b against the biasing force of the biasing springs 114, and the contact state between the plurality of rotating bodies 80a and 80b is released. In a case in which the operation lever 88c is returned to the original position, the contact state between the plurality of rotating bodies 80a and 80b is returned to the original state.

### Rubbing Roll

### Configuration Example of Rubbing Roll

In the present example, as shown in FIGS. 6 and 7, the rubbing roll 90 consists of a plurality of rotating bodies 90a and 90b that are disposed to face each other with respect to the medium S. In the present example, the rotating bodies 90a and 90b constituting the rubbing roll 90 have a structure in which a surface of a solid shaft 93 made of metal such as SUS is coated with a nonwoven fabric 94. Here, as the nonwoven fabric 94, for example, a felt or a microfiber cloth having a thickness equal to or less than 1 mm is used. The nonwoven fabric 94 is fixed to the shaft 93 by an adhesive, a double-sided tape, or the like.

### Drive Method of Rubbing Roll

In addition, in the present example, the rubbing roll 90 uses both the rotating bodies 90a and 90b as driving rolls. That is, a drive force from a drive motor 96 is transmitted to both the rotating bodies 90a and 90b through a drive transmission mechanism 97 (specifically, 97a and 97b) such as a drive transmission gear train. Here, the drive transmission mechanisms 97a and 97b may be partially shared or may be separately provided. In the present example, the drive transmission mechanism 97b shares the drive transmission mechanism 97a, and is configured to add a transmission gear for changing a rotation direction with respect to a transmission gear of the final stage of the drive transmission mechanism 97a.

### Velocity Condition of Rubbing Roll

As shown in FIGS. 6 and 7, the rubbing roll 90 need only rub the surface of the medium S in the direction opposite to the transport direction of the medium S at the velocity v1 different from the transport velocity v0 of the transport roll 80.

In the present example, the rubbing roll 90 is selected (i) to rotate in the direction opposite to the transport direction of the medium S in a contact region CN1 between the plurality of rotating bodies 90a and 90b. That is, the rotating body 90a located on the upper side is rotated in a clockwise direction, and the rotating body 90b located on the lower side is rotated in a counterclockwise direction.

The reason for the selection is based on the viewpoint that the rubbing resistance caused by the rubbing roll 90 is increased. In a case of such a selection, a difference in velocity (v0−v1) between the rubbing roll 90 and the transport roll 80 can be increased. Here, the velocity v1 of the rubbing roll 90 may be appropriately selected, but is set to about 5 to 10 times v0 in the absolute value in the present example.

In order to rub the surface of the medium S via the rubbing roll 90 in the direction opposite to the transport direction of the medium S, in addition to (i), (ii) to maintain a stop state in the contact region CN1 or (iii) to rotate in the direction identical to the transport direction of the medium S at the velocity lower than the transport velocity v0 of the medium S in the contact region CN1 may be adopted. However, it should be noted that, in the methods of (ii) and (iii), the rubbing resistance caused by the rubbing roll 90 is smaller than in the method of (i).

### Contact/Separation Configuration Example of Rubbing Roll

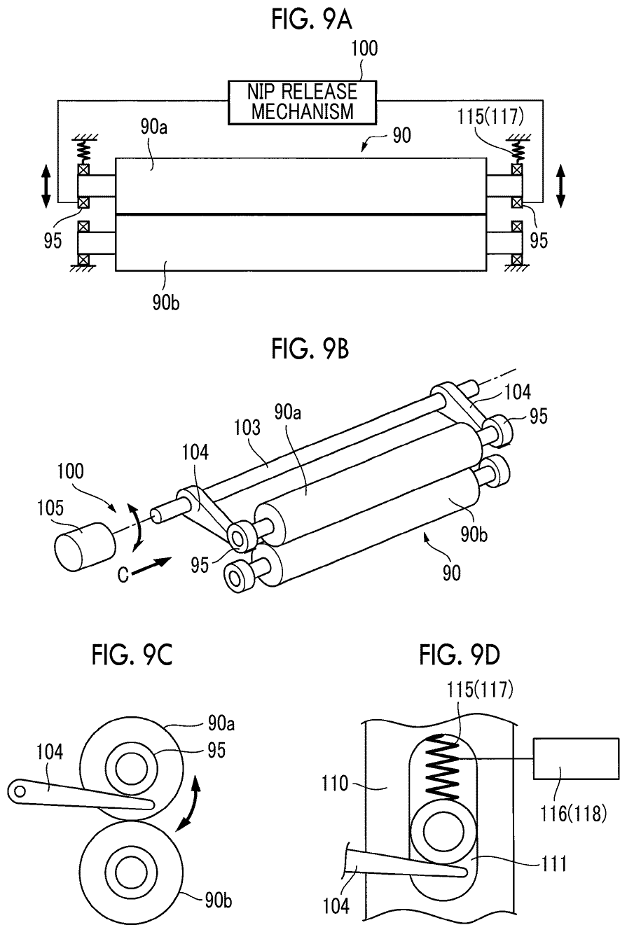

In the present example, as shown in FIGS. 6, 9A, and 9B, one rotating body 90a of the rubbing roll 90 is provided with a nip release mechanism 100 as a contact/separation section that is movable between a contact position in contact with the other rotating body 90b and a non-contact position separated from the contact position. The nip release mechanism 100 supports both ends of the shaft 93 of the rotating body 90a, and switches between a nip state of the rubbing roll 90 (corresponding to a contact state between the plurality of rotating bodies 90a and 90b) and a release state (corresponding to a non-contact state between the plurality of rotating bodies 90a and 90b) based on a control signal. In the present example, as shown in FIG. 9B, the nip release mechanism 100 has, on both sides of a support shaft 103 that is rotatable, support arms 104 that protrude radially with respect to the support shaft 103. The support arms 104 support bearings 95 provided at both ends of the shaft 93 of one rotating body 90a located on the upper side from the lower side.

In the present example, the bearings 95 provided at both ends of the shaft 93 are supported by a support panel 110 to be movable up and down. Specifically, an elongated hole 111 extending in an up-down direction is formed in the support panel 110. The bearings 95 provided at both ends of the shaft 93 of the rotating body 90a are held to be slidable in the elongated hole 111.

Further, a nip release motor 105 capable of forward and backward rotation is provided directly or via a drive transmission gear train (not shown) at one end of the support shaft 103. As shown in FIGS. 9B and 9C, the nip release motor 105 rotates the support shaft 103 forward and backward and swing the support arms 104 in a predetermined angle range.

### Setting of Nip Pressure of Rubbing Roll

In the present example, as shown in FIGS. 9A and 9D, biasing springs 115 as biasing sections for adjusting a nip pressure (corresponding to a contact pressure of a contact region between the plurality of rotating bodies 90a and 90b) of the rubbing roll 90 are provided in the rubbing roll 90. The biasing spring 115 is composed of, for example, a compression coil spring. The biasing spring 115 is interposed, for example, between an upper edge portion of the elongated hole 111 and the bearing 95 of the rotating body 90a. In addition, an adjustment portion 116 that adjusts a compression deformation amount is provided in the biasing spring 115. The adjustment portion 116 variably sets the biasing force of the biasing spring 115 by adjusting the compression deformation amount. As a result, the nip pressure of the rubbing roll 90 is set.

### Adjustment of Frictional Force of Rubbing Roll

In the present example, the rubbing roll 90 and the transport roll 80 come into contact with the medium S that moves. In this case, in a case in which the medium S passes through the contact region CN1 of the rubbing roll 90, as shown in FIG. 7, a frictional force f1 is generated between the rubbing roll 90 and the medium S. On the other hand, in a case in which the medium S passes through the contact region CN0 of the transport roll 80, a frictional force f0 is generated between the transport roll 80 and the medium S.

In the present example, the frictional force f0 between the plurality of rotating bodies 80a and 80b constituting the transport roll 80 and the medium S is required to be larger than the frictional force f1 between the plurality of rotating bodies 90a and 90b constituting the rubbing roll 90 and the medium S.

Here, in a case in which a normal force acting on the contact region CN0 of the transport roll 80 is denoted by U0, a kinetic friction coefficient between the transport roll 80 and the medium S is denoted by μ0, a normal force acting on the contact region CN1 of the rubbing roll 90 is denoted by U1, and a kinetic friction coefficient between the rubbing roll 90 and the medium S is denoted by μ1, the relationship is represented as follows.

$$f 0 = μ0 \cdot U 0 \\ f 1 = μ1 \cdot U 1$$

In order to satisfy the condition of f0>f1, since the kinetic friction coefficients μ0 and μ1 are values dependent on the materials and the like, the biasing forces of the biasing springs 114 and 115 that affect the normal forces U0 and U1 need only be adjusted in consideration of the respective kinetic friction coefficients. Here, since U0 is selected such that the transportability of the medium S is ensured to be appropriate, for example, it is preferable to mostly adjust the biasing force of the biasing spring 115 and appropriately adjust the frictional force f1.

### Control System of Post-Processing Device

In the present exemplary embodiment, as shown in FIG. 6, a control device 120 that controls the respective elements (imaging engine 22, medium transport system 23, fixing device 24, post-processing device 25, and the like) of the image forming system 20 is provided.

The control device 120 is configured by a microcomputer including various processors. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

In the present example, in the horizontal transport path 64, a position sensor 130 as a position detection section is provided upstream of the post-processing device 25 in the transport direction of the medium S. Here, the position sensor 130 may be appropriately selected as long as the position sensor 130 detects a timing at which a leading end part of the medium S passes through. Specific examples of the position sensor 130 include a mechanical switch such as a limit switch and an optical sensor having a light emitting unit and a light receiving unit.

In the present example, the control device 120 is a device in which a necessary program, such as an imaging program of the image forming system 20 and a control processing program of the post-processing device 25, is installed in advance in a memory (not shown). The control device 120 executes the imaging program by turning on a start switch (not shown), and sends out a control signal necessary for imaging processing to the imaging engine 22, the medium transport system 23, and the fixing device 24.

Further, now, it is assumed that the leading end part of the medium S that has passed through the fixing device 24 has passed through the position sensor 130. In this case, the control device 120 imports detection information from the position sensor 130 into the processor and executes the control processing program of the post-processing device 25. Then, the control device 120 sends out a control signal for nip release to the nip release mechanism 100. Further, the control device 120 sends out a control signal for driving to each of the drive motors 86 and 96 of the transport roll 80 and the rubbing roll 90.

### Operation of Post-Processing Device

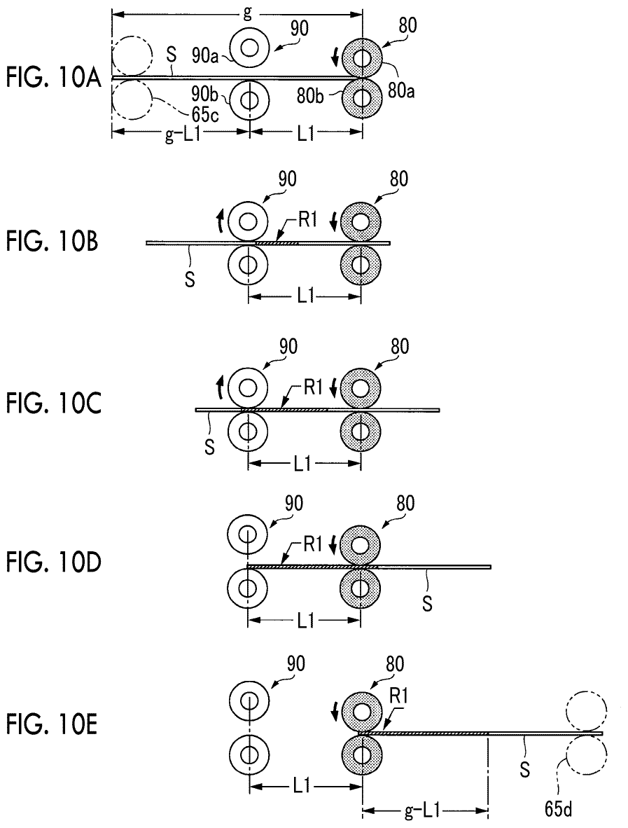

In the present example, the control device 120 executes control processing of the post-processing device 25, as shown in FIGS. 10A to 10E.

In FIGS. 10A to 10E, a distance between the rubbing roll 90 and the transport roll 80 is denoted by L1, and the transport direction length of the medium S is denoted by g.

FIG. 10A shows a state in which the leading end part of the medium S enters the transport roll 80. In this case, the medium S is transported by the transport roll 65c for feeding located on the inlet side of the post-processing device 25, slips through the rubbing roll 90 located at a release position, and enters the transport roll 80.

FIG. 10B shows a state after the leading end part of the medium S has entered the transport roll 80. In this case, the rubbing roll 90 is disposed at a nip position to start the driving. Then, the medium S is transported in a state of being pulled in the transport direction between the rubbing roll 90 and the transport roll 80. Then, the rubbing operation using the rubbing roll 90 is performed from the middle of the medium S in the transport direction. In FIG. 10B, R1 indicates a rubbing region (corresponding to a hatched region in the diagonally lower left in FIG. 10B) of the rubbing roll 90 with respect to the medium S.

FIG. 10C shows a state in which the medium S is further transported by the transport roll 80. In this case, the rubbing operation using the rubbing roll 90 is continuously performed.

FIG. 10D shows a state in which a trailing end part of the medium S passes through the rubbing roll 90. In this case, the rubbing roll 90 is disposed at the release position, and the driving is stopped. During this period, the rubbing operation using the rubbing roll 90 is performed from the middle of the medium S in the transport direction to the trailing end part of the medium S.

FIG. 10E shows a state immediately before the trailing end part of the medium S passes through the transport roll 80. In this case, the leading end part of the medium S is nipped and transported by the transport roll 65d located on the outlet side of the post-processing device 25. Therefore, the transportability of the medium S discharged from the post-processing device 25 is well maintained.

As described above, in the present example, the post-processing device 25 rubs both the front and back surfaces of the medium S in the rubbing region R1 of the rubbing roll 90.

### Form Change in Wax on Medium Before and After Post-Processing

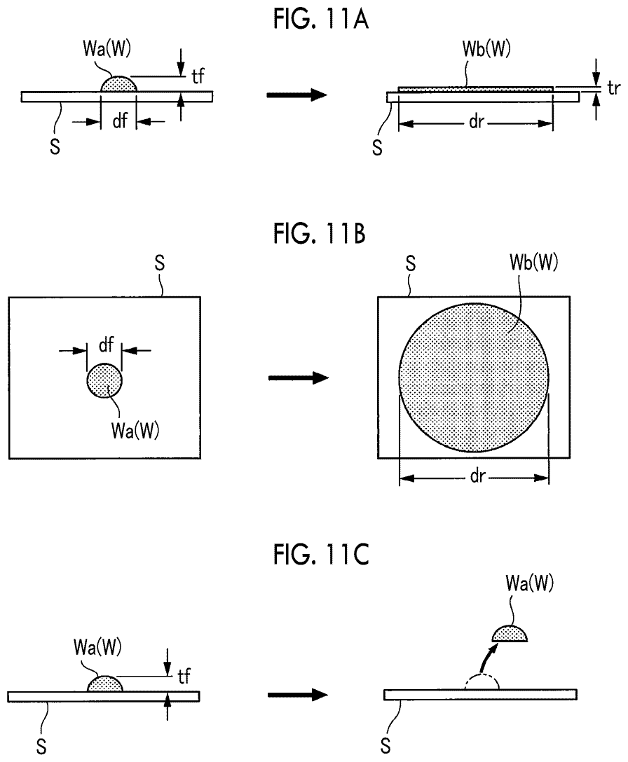

FIG. 11A shows a form change in the wax W before and after post-processing using the post-processing device 25 in a case in which the film medium having the smooth surface is used as the medium S.

In FIG. 11A, it can be seen that the wax W of the medium S before the post-processing passes through the fixing region FR and then is cooled and solidified to be the granular mass Wa (granular mass having a diameter df of, for example, 5 μm and a thickness tf of, for example, 0.3 μm).

However, after the post-processing using the post-processing device 25, the wax W consisting of the granular mass Wa before the post-processing is hardly visible. The granular mass Wa before the post-processing is spread in a flattened manner by the rubbing operation using the rubbing roll 90. As a result, it is confirmed that the form of the wax W is changed from the granular mass Wa to the thin film-like layer Wb.

In the present example, the wax W consisting of the thin film-like layer Wb is changed to have a smaller thickness tr and a larger diameter dr than the granular mass Wa.

In the present example, as shown in FIG. 11A and FIG. 11B, in the thin film-like layer Wb, the thickness tr is changed to be about ⅓ of the thickness tf (for example, 0.3 μm) before the processing, and the diameter dr is widely spread to be about 5 to 6 times the diameter df (for example, 5 μm) before the processing.

In this state, it is confirmed that the wax W consisting of the thin film-like layer Wb does not have the light scattering phenomenon and cannot be visually confirmed to exist on the medium S.

### Condition for Making Wax Less Visible

Here, regarding the form of the wax W after the post-processing using the post-processing device 25, it is presumed that the granular mass Wa is spread into the thin film-like layer Wb to be in a less visible state.

In this case, in a case in which a relationship between the thickness tr of the thin film-like layer Wb and a condition for making the wax less visible is examined, it is confirmed that, for example, it is preferable that the following relationship is satisfied.

tr≤0.15 μm.

A method of measuring the thickness of the wax W and an analysis of a measurement result will be described in detail in Examples described below.

### Comparative Example 1

As shown in FIG. 11C, the post-processing device according to the present comparative example removes the wax W consisting of the granular mass Wa transferred to the medium S with a removal member such as a blade, substantially in the same manner as in JP2002-91205A (Mode for Carrying Out the Invention and FIG. 6) or JP2005-266079A (Best Mode for Carrying Out the Invention and FIG. 2).

In the present example, in a case in which the wax W transferred to the medium S is to be mechanically completely removed, it is necessary to strongly press the removal member against the surface of the medium S. In this case, the image held on the medium S may be damaged, and it cannot be said that this measure is a desired measure.

### ⊚ Modification Aspect

(1) In the present exemplary embodiment, in a case in which the rubbing roll 90 is disposed at the release position, the driving of the plurality of rotating bodies 90a and 90b is stopped. However, the rubbing roll 90 may be disposed at the release position without stopping the driving of the plurality of rotating bodies 90a and 90b.

(2) In the present exemplary embodiment, the post-processing device 25 performs the post-processing on the sheet-like medium S, but the present invention is not limited to this, and the post-processing may be performed on a continuous medium such as a roll-like medium. In this case, unlike the sheet-like medium S, the transport roll 80 can always maintain a state in which the continuous medium S is nipped. Therefore, this configuration is preferable, for example, in that a timing of the nip release of the rubbing roll 90 is controlled, so that the rubbing processing using the rubbing roll 90 can be appropriately performed on a portion of the continuous medium that requires the rubbing processing.

### ⊚ Exemplary Embodiment 2

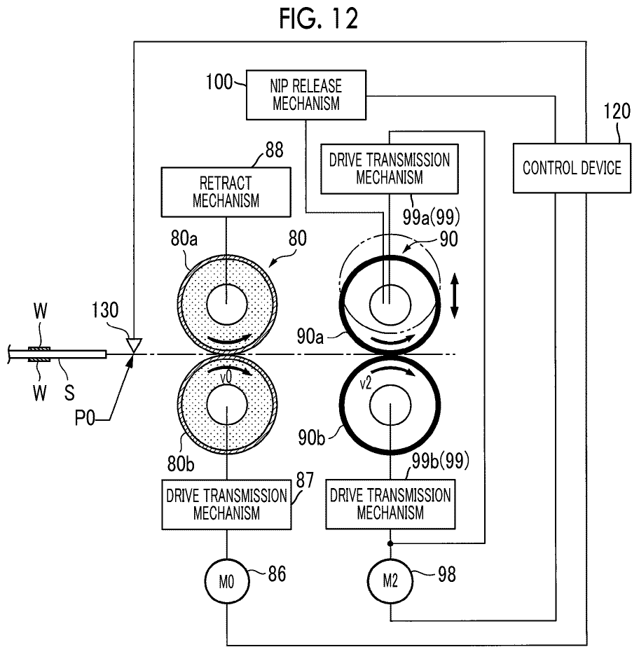

FIG. 12 is an explanatory diagram showing a major part of a post-processing device according to Exemplary Embodiment 2.

### Basic Configuration of Post-Processing Device

In FIG. 12, the post-processing device 25 includes a transport roll 80 as a transport section as a transport section that transports the medium S at a transport velocity v0 as in Exemplary Embodiment 1, and a rubbing roll 90 as a rubbing section that is located downstream of the transport roll 80 in the transport direction of the medium S and that rubs the surface of the medium S in a direction identical to the transport direction of the medium S at the velocity v2 higher than the transport velocity v0 unlike Exemplary Embodiment 1, and the transport roll 80 and the rubbing roll 90 are appropriately arranged and mounted in a housing (not shown).

In the present example, the rubbing roll 90 is configured to rub both the front and back surfaces of the medium S, as in Exemplary Embodiment 1.

In FIG. 12, reference numeral 120 is a control device that controls the respective elements of the image forming system 20, and reference numeral 130 is a position sensor for detecting a transport position of the medium S.

### Transport Roll

### Configuration Example and Drive Method of Transport Roll

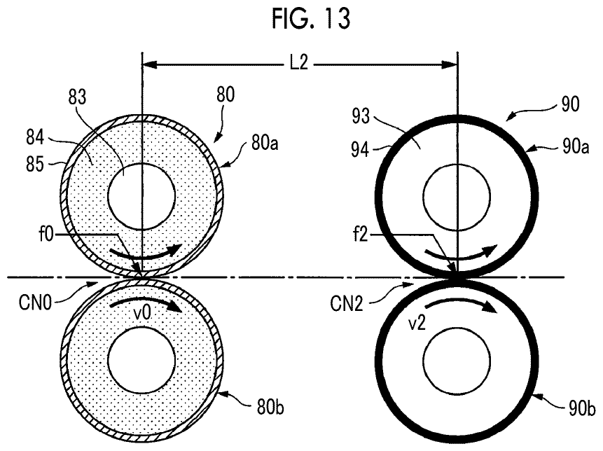

In the present example, as shown in FIGS. 12 and 13, the transport roll 80 consists of a plurality of rotating bodies 80a and 80b that are disposed to face each other with respect to the medium S. The rotating bodies 80a and 80b constituting the transport roll 80 have a three-layer structure including a shaft 83, an elastic layer 84, and a mold-releasing layer 85, as in Exemplary Embodiment 1.

In the present example, the drive method of the transport roll 80 is a method of using one rotating body 80b of the plurality of rotating bodies 80a and 80b as a driving roll, and transmitting a drive force from the drive motor 86 to the driving roll via the drive transmission mechanism 87, substantially in the same manner as in Exemplary Embodiment 1.

### Retract Configuration Example of Transport Roll

In the present example, as shown in FIGS. 12, 8A, and 8B, the retract mechanism 88 (support shaft 88a, support arms 88b, and operation lever 88c) as a retractable retract section is provided in one rotating body 80a of the transport roll 80.

### Setting of Nip Pressure of Transport Roll

As in Exemplary Embodiment 1, as shown in FIG. 8A, biasing springs 114 as biasing sections for adjusting a nip pressure (corresponding to a contact pressure of the contact region CN0 between the plurality of rotating bodies 80a and 80b) of the transport roll 80 are provided at both ends of one rotating body 80a of the transport roll 80. The biasing spring 114 is composed of, for example, a compression coil spring, and adjusts a compression deformation amount via an adjustment portion (not shown).

### Rubbing Roll

### Configuration Example of Rubbing Roll

In the present example, as shown in FIGS. 12 and 13, the rubbing roll 90 consists of a plurality of rotating bodies 90a and 90b that are disposed to face each other with respect to the medium S. In the present example, the rotating bodies 90a and 90b constituting the rubbing roll 90 have a structure in which a surface of a solid shaft 93 made of metal such as SUS is coated with a nonwoven fabric 94, as in Exemplary Embodiment 1.

### Drive Method of Rubbing Roll

The rubbing roll 90 also uses both the rotating bodies 90a and 90b as driving rolls, as in Exemplary Embodiment 1. In the present example, a drive force from a drive motor 98 is transmitted to both the rotating bodies 90a and 90b through a drive transmission mechanism 99 (specifically, 99a and 99b) such as a drive transmission gear train. Here, the drive transmission mechanisms 99a and 99b may be partially shared or may be separately provided, as in the drive transmission mechanism 97.

### Velocity Condition of Rubbing Roll

As shown in FIGS. 12 and 13, the rubbing roll 90 need only rub the surface of the medium S in the direction identical to the transport direction of the medium S at the velocity v2 higher than the transport velocity v0 of the transport roll 80.

In the present example, the rubbing roll 90 is selected to rotate in the direction identical to the transport direction of the medium S in a contact region CN2 between the plurality of rotating bodies 90a and 90b. That is, the rotating body 90a located on the upper side is rotated in a counterclockwise direction, and the rotating body 90b located on the lower side is rotated in a clockwise direction.

In a case of such a selection, a difference in velocity (v2−v0) between the rubbing roll 90 and the transport roll 80 is larger than zero. Therefore, the medium S is transported by the transport roll 80 at the transport velocity v0. In this situation, in a case in which the medium S passes through the rubbing roll 90, the rubbing operation using the rubbing roll 90 on the surface of the medium S is ensured.

Here, the velocity v2 of the rubbing roll 90 may be appropriately selected. However, in order to increase the rubbing resistance caused by the rubbing roll 90, for example, it is preferable to set v2 to be large. In the present example, the value is set to about 5 to 10 times v0 in the absolute value.

### Contact/Separation Configuration Example of Rubbing Roll

In the present example, the rubbing roll 90 includes a nip release mechanism 100 as in Exemplary Embodiment 1. As shown in FIGS. 12, 9A, and 9B, the nip release mechanism 100 supports both ends of the shaft 93 of the rotating body 90a, and switches between a nip state of the rubbing roll 90 (corresponding to a contact state between the plurality of rotating bodies 90a and 90b) and a release state (corresponding to a non-contact state between the plurality of rotating bodies 90a and 90b) based on a control signal.

In the present example, as shown in FIGS. 9B and 9C, the nip release mechanism 100 has the same constituent elements (support shaft 103, support arms 104, and nip release motor 105) as in Exemplary Embodiment 1.

### Setting of Nip Pressure of Rubbing Roll

In the present example, as shown in FIGS. 9A and 9D, biasing springs 117 as biasing sections for adjusting a nip pressure (corresponding to a contact pressure of a contact region of the plurality of rotating bodies 90a and 90b) of the rubbing roll 90 are provided in the rubbing roll 90, as in Exemplary Embodiment 1. In addition, an adjustment portion 118 that adjusts a compression deformation amount is provided in the biasing spring 117. The adjustment portion 118 variably sets the biasing force of the biasing spring 117 by adjusting the compression deformation amount.

### Adjustment of Frictional Force of Rubbing Roll

In the present example, the rubbing roll 90 and the transport roll 80 come into contact with the medium S that moves. In this case, in a case in which the medium S passes through the contact region CN2 of the rubbing roll 90, as shown in FIG. 13, a frictional force f2 is generated between the rubbing roll 90 and the medium S. On the other hand, in a case in which the medium S passes through the contact region CN0 of the transport roll 80, a frictional force f0 is generated between the transport roll 80 and the medium S.

In the present example, the frictional force f0 between the plurality of rotating bodies 80a and 80b constituting the transport roll 80 and the medium S is required to be larger than the frictional force f2 between the plurality of rotating bodies 90a and 90b constituting the rubbing roll 90 and the medium S.

Here, in a case in which a normal force acting on the contact region CN0 of the transport roll 80 is denoted by U0, a kinetic friction coefficient between the transport roll 80 and the medium S is denoted by μ0, a normal force acting on the contact region CN2 of the rubbing roll 90 is denoted by U2, and a kinetic friction coefficient between the rubbing roll 90 and the medium S is denoted by μ2, the relationship is represented as follows.

$$f 0 = μ0 \cdot U 0 \\ f 2 = μ2 \cdot U 1$$

In order to satisfy the condition of f0>f2, since the kinetic friction coefficients μ0 and μ2 are values dependent on the materials and the like, the biasing forces of the biasing springs 114 and 117 that affect the normal forces U0 and U2 need only be adjusted in consideration of the respective kinetic friction coefficients. Here, since U0 is selected such that the transportability of the medium S is ensured to be appropriate, for example, it is preferable to mostly adjust the biasing force of the biasing spring 117 and appropriately adjust the frictional force f2.

### Operation of Post-Processing Device

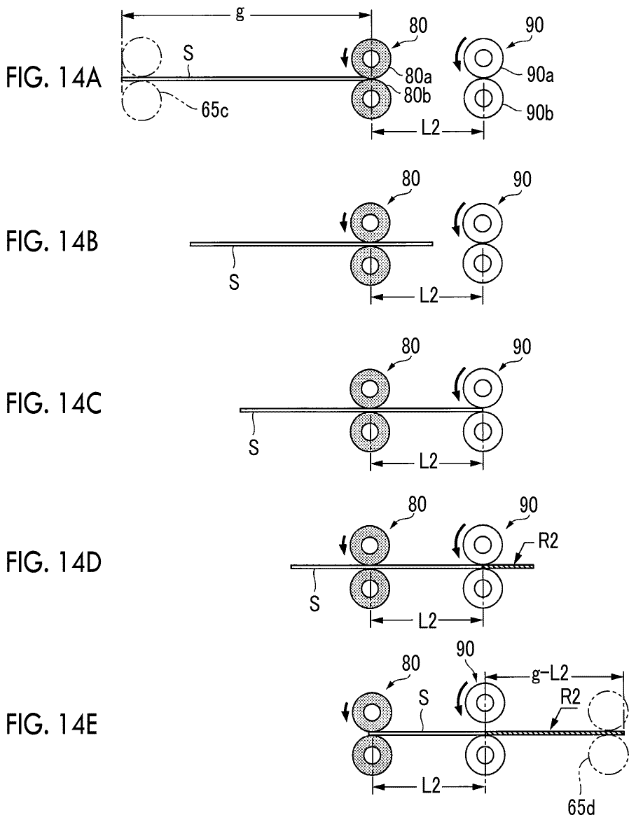

In the present example, the control device 120 executes control processing of the post-processing device 25, as shown in FIGS. 14A to 14E.

In FIGS. 14A to 14E, a distance between the rubbing roll 90 and the transport roll 80 is denoted by L2, and the transport direction length of the medium S is denoted by g.

FIG. 14A shows a state in which the leading end part of the medium S enters the transport roll 80. In this case, the medium S is transported by the transport roll 65c for feeding located on the inlet side of the post-processing device 25 and enters the transport roll 80.

FIG. 14B shows a state after the leading end part of the medium S has entered the transport roll 80. In this case, the transport roll 80 transports the medium S at the transport velocity v0 to be directed to the rubbing roll 90. In this case, the rubbing roll 90 is disposed at the nip position and is in a standby state in which the driving is started.

FIG. 14C shows a state in which the leading end part of the medium S has entered the rubbing roll 90. In this case, the medium S is transported in a state of being pulled in the transport direction between the rubbing roll 90 and the transport roll 80. Therefore, the rubbing operation using the rubbing roll 90 is started from the leading end part of the medium.

FIG. 14D shows a state in which the leading end part of the medium S passes through the rubbing roll 90. In this case, the rubbing operation using the rubbing roll 90 is performed from the leading end part of the medium S toward the downstream side of the medium S in the transport direction. In FIG. 14D, R2 indicates a rubbing region (corresponding to a hatched region in the diagonally lower right in FIG. 14D) of the rubbing roll 90 with respect to the medium S.

FIG. 14E shows a state immediately before the trailing end part of the medium S passes through the transport roll 80. In this case, the rubbing roll 90 is disposed at the release position, and the driving is stopped. During this period, the rubbing operation using the rubbing roll 90 is performed from the leading end part of the medium S to the middle of the medium S in the transport direction. The rubbing operation using the rubbing roll 90 is stopped at a stage in which the rubbing roll 90 is disposed at the release position. In FIG. 14E, the rubbing region R2 of the rubbing roll 90 is implemented in a range of approximately g-L2.

In addition, the leading end part of the medium S is nipped and transported by the transport roll 65d located on the outlet side of the post-processing device 25. Therefore, the transportability of the medium S discharged from the post-processing device 25 is well maintained.

As described above, in the present example, the post-processing device 25 rubs both the front and back surfaces of the medium S in the rubbing region R2 of the rubbing roll 90.

### Form Change in Wax on Medium Before and After Post-Processing

In the present exemplary embodiment as well, it is confirmed that, before and after the post-processing using the post-processing device 25, the form of the wax W is changed from the granular mass Wa to the thin film-like layer Wb. In this case, it is confirmed that, in a case in which the wax W after the post-processing is changed to the thin film-like layer Wb having the thickness tr equal to or less than 0.15 μm, the wax W is hardly visible to the naked eye.

### ⊚ Exemplary Embodiment 3

### Basic Configuration of Post-Processing Device

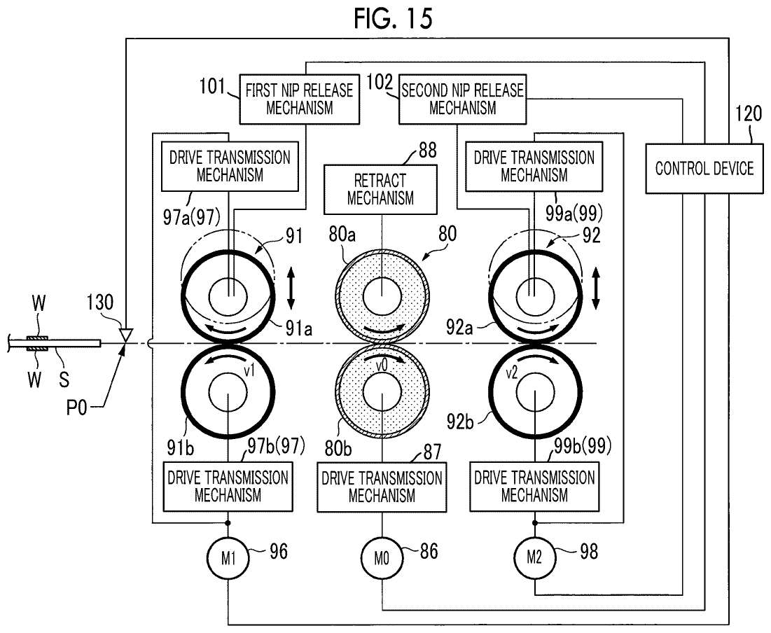

FIG. 15 is an explanatory diagram showing a major part of a post-processing device according to Exemplary Embodiment 3.

In FIG. 15, the post-processing device 25 is a combination of the post-processing device 25 (see FIG. 6) of the disposition example according to Exemplary Embodiment 1 and the post-processing device 25 (see FIG. 12) of the disposition example according to Exemplary Embodiment 2.

In the present example, as shown in FIG. 15, the post-processing device 25 includes a transport roll 80 as a transport section that transports the medium S at the predetermined transport velocity v0 by nipping the medium S, a first rubbing roll 91 as a rubbing section that is located upstream of the transport roll 80 in the transport direction of the medium S and that rubs the surface of the medium S in a direction opposite to the transport direction of the medium S at the velocity v1 different from the transport velocity v0, and a second rubbing roll 92 as a rubbing section that is located downstream of the transport roll 80 in the transport direction of the medium S and that rubs the surface of the medium S in the direction identical to the transport direction of the medium S at the velocity v2 higher than the transport velocity v0, and the transport roll 80, the first rubbing roll 91, and the second rubbing roll 92 are appropriately arranged and mounted in a housing (not shown).

In the present example, the first rubbing roll 91 and the second rubbing roll 92 are configured to rub both the front and back surfaces of the medium S.

### Transport Roll

### Configuration Example and Drive Method of Transport Roll

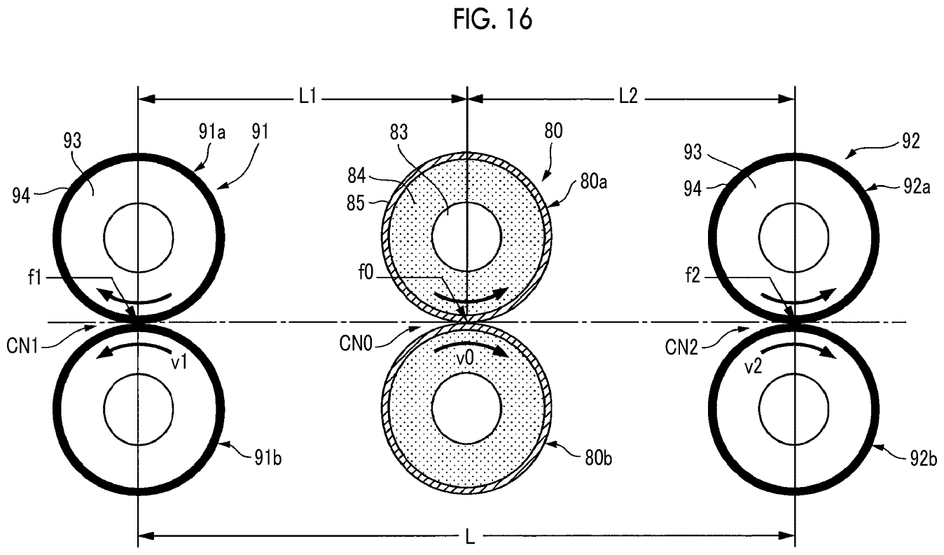

In the present example, as shown in FIGS. 15 and 16, the transport roll 80 consists of a plurality of rotating bodies 80a and 80b that are disposed to face each other with respect to the medium S. The plurality of rotating bodies 80a and 80b constituting the transport roll 80 have a three-layer structure including a shaft 83, an elastic layer 84, and a mold-releasing layer 85, as in Exemplary Embodiments 1 and 2.

In the present example, the drive method of the transport roll 80 is a method of using one rotating body 80b of the plurality of rotating bodies 80a and 80b as a driving roll, and transmitting a drive force from the drive motor 86 to the driving roll via the drive transmission mechanism 87, substantially in the same manner as in Exemplary Embodiments 1 and 2.

### Retract Configuration Example of Transport Roll

In the present example, as shown in FIGS. 15, 8A, and 8B, the retract mechanism 88 (support shaft 88a, support arms 88b, and operation lever 88c) as a retractable retract section is provided in one rotating body 80a of the transport roll 80.

### Setting of Nip Pressure of Transport Roll

As in Exemplary Embodiment 1, as shown in FIG. 8A, biasing springs 114 as biasing sections for adjusting a nip pressure (corresponding to a contact pressure of the contact region CN0 between the plurality of rotating bodies 80a and 80b) of the transport roll 80 are provided at both ends of one rotating body 80a of the transport roll 80. The biasing spring 114 is composed of, for example, a compression coil spring, and adjusts a compression deformation amount via an adjustment portion (not shown).

### First Rubbing Roll

### Configuration Example of First Rubbing Roll

In the present example, as shown in FIGS. 15 and 16, the first rubbing roll 91 consists of a plurality of rotating bodies 91a and 91b that are disposed to face each other with respect to the medium S. In the present example, the rotating bodies 91a and 91b constituting the first rubbing roll 91 include a shaft 93 and a nonwoven fabric 94, as in the rubbing roll 90 according to Exemplary Embodiment 1.

### Drive Method of First Rubbing Roll

In the present example, the first rubbing roll 91 uses both the rotating bodies 91a and 91b as driving rolls. That is, the same drive method as the drive method of the rubbing roll 90 according to Exemplary Embodiment 1 (drive motor 96 and drive transmission mechanism 97 (97a and 97b)) is adopted for both the rotating bodies 91a and 91b.

### Velocity Condition of First Rubbing Roll

As shown in FIGS. 15 and 16, the first rubbing roll 91 has the same velocity condition as the rubbing roll 90 according to Exemplary Embodiment 1. Specifically, the first rubbing roll 91 need only rub the surface of the medium S in the direction opposite to the transport direction of the medium S at the velocity v1 different from the transport velocity v0 of the transport roll 80.

### Contact/Separation Configuration Example of First Rubbing Roll

In the present example, as shown in FIGS. 15, 9A, and 9B, one rotating body 91a of the first rubbing roll 91 is provided with a first nip release mechanism 101 as a contact/separation section that is movable between a contact position in contact with the other rotating body 91b and a non-contact position separated from the contact position. The first nip release mechanism 101 supports both ends of the shaft 93 of the rotating body 91a, and switches between a nip state of the first rubbing roll 91 (corresponding to a contact state between the plurality of rotating bodies 91a and 91b) and a release state (corresponding to a non-contact state between the plurality of rotating bodies 91a and 91b) based on a control signal. In the present example, as shown in FIGS. 15 and 9B, the first nip release mechanism 101 has the same components (support shaft 103, support arms 104, and nip release motor 105) as the nip release mechanism 100 according to Exemplary Embodiment 1.

### Setting of Nip Pressure of First Rubbing Roll

In the present example, as shown in FIGS. 9A and 9D, biasing springs 115 as biasing sections for adjusting a nip pressure (corresponding to a contact pressure of a contact region of the plurality of rotating bodies 91a and 91b) of the first rubbing roll 91 are provided in the first rubbing roll 91, as in the rubbing roll 90 according to Exemplary Embodiment 1. The biasing spring 115 is composed of, for example, a compression coil spring. An adjustment portion 116 that adjusts a compression deformation amount is provided in the biasing spring 115.

### Adjustment of Frictional Force of First Rubbing Roll

In the present example, the first rubbing roll 91 corresponds to the rubbing roll 90 according to Exemplary Embodiment 1.

Therefore, in the present example, the frictional force f0 between the plurality of rotating bodies 80a and 80b constituting the transport roll 80 and the medium S is required to be larger than the frictional force f1 between the plurality of rotating bodies 91a and 91b constituting the first rubbing roll 91 and the medium S.

### Second Rubbing Roll

### Configuration Example of Second Rubbing Roll

In the present example, as shown in FIGS. 15 and 16, the second rubbing roll 92 consists of a plurality of rotating bodies 92a and 92b that are disposed to face each other with respect to the medium S. In the present example, the rotating bodies 92a and 92b constituting the second rubbing roll 92 include a shaft 93 and a nonwoven fabric 94, as in the rubbing roll 90 according to Exemplary Embodiment 2.

### Drive Method of Second Rubbing Roll

The second rubbing roll 92 also uses both the rotating bodies 92a and 92b as driving rolls, as in the first rubbing roll 91. That is, the same drive method as the drive method of the rubbing roll 90 according to Exemplary Embodiment 2 (drive motor 98 and drive transmission mechanism 99 (99a and 99b)) is adopted for both the rotating bodies 92a and 92b.

### Velocity Condition of Second Rubbing Roll

As shown in FIGS. 15 and 16, the second rubbing roll 92 has the same velocity condition as the rubbing roll 90 according to Exemplary Embodiment 2. Specifically, the second rubbing roll 92 need only rub the surface of the medium S in the direction identical to the transport direction of the medium S at the velocity v2 higher than the transport velocity v0 of the transport roll 80.

### Contact/Separation Configuration Example of Second Rubbing Roll

In the present example, as shown in FIGS. 15, 9A, and 9B, one rotating body 92a of the second rubbing roll 92 is provided with a second nip release mechanism 102 as a contact/separation section that is movable between a contact position in contact with the other rotating body 92b and a non-contact position separated from the contact position. The second nip release mechanism 102 supports both ends of the shaft 93 of the rotating body 92a, and switches between a nip state of the second rubbing roll 92 (corresponding to a contact state between the plurality of rotating bodies 92a and 92b) and a release state (corresponding to a non-contact state between the plurality of rotating bodies 92a and 92b) based on a control signal. In the present example, as shown in FIGS. 15 and 9B, the second nip release mechanism 102 has the same components (support shaft 103, support arms 104, and nip release motor 105) as the nip release mechanism 100 according to Exemplary Embodiment 2.

### Setting of Nip Pressure of Second Rubbing Roll

In the present example, as shown in FIGS. 9A and 9D, biasing springs 117 as biasing sections for adjusting a nip pressure (corresponding to a contact pressure of a contact region of the plurality of rotating bodies 92a and 92b) of the second rubbing roll 92 are provided in the second rubbing roll 92, as in the rubbing roll 90 according to Exemplary Embodiment 2. The biasing spring 117 is composed of, for example, a compression coil spring. An adjustment portion 118 that adjusts a compression deformation amount is provided in the biasing spring 117.

### Adjustment of Frictional Force of Second Rubbing Roll

In the present example, the second rubbing roll 92 corresponds to the rubbing roll 90 according to Exemplary Embodiment 2.

Therefore, in the present example, the frictional force f0 between the plurality of rotating bodies 80a and 80b constituting the transport roll 80 and the medium S is required to be larger than the frictional force f2 between the plurality of rotating bodies 92a and 92b constituting the second rubbing roll 92 and the medium S.

### Positional Relationship Among Transport Roll and First and Second Rubbing Rolls

In the present example, the positional relationship among the transport roll 80, the first rubbing roll 91, and the second rubbing roll 92 is as follows.

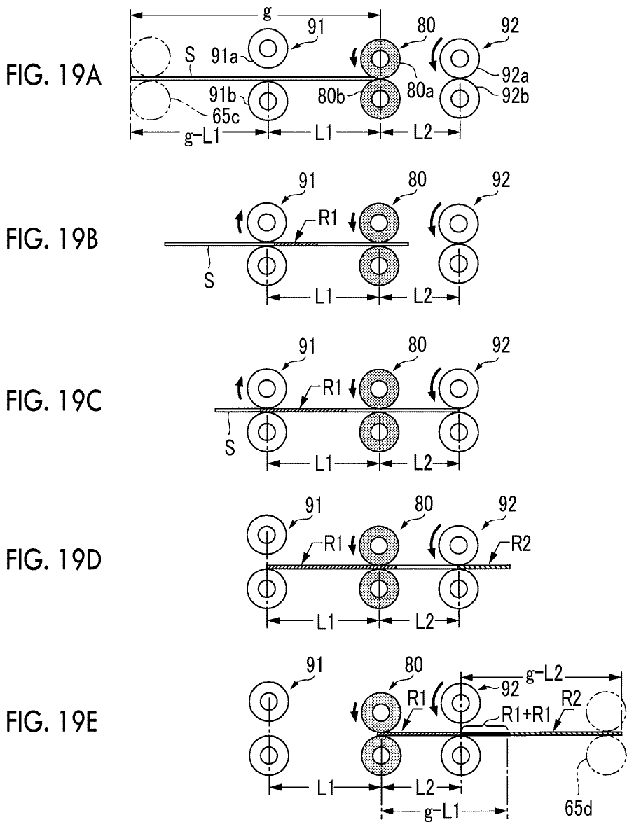

As shown in FIG. 16, in a case in which a distance between a circumferential center of the contact region CN1 of the first rubbing roll 91 and a circumferential center of the contact region CN2 of the second rubbing roll 92 is denoted by L, a distance between the circumferential center of the contact region CN1 of the first rubbing roll 91 and a circumferential center of the contact region CN0 of the transport roll 80 is denoted by L1, a distance between the circumferential center of the contact region CN0 of the transport roll 80 and the circumferential center of the contact region CN2 of the second rubbing roll 92 is denoted by L2, and the transport direction length of the medium S is denoted by g (see FIG. 19A), the selection is made such that Expressions (I) and (II) are satisfied.

L<g (I)

L1, L2<g/2 (II)

Here, L=L1+L2.

The circumferential center of the contact region CN (CN1 or CN2) refers to an intersection between a straight line connecting axis centers of the plurality of rotating bodies 80a and 80b (91a and 91b, or 92a and 92b) and the contact region CN (CN1 or CN2).

In the present example, Expression (I) is a condition for rubbing the entire region of both the front and back surfaces of the medium S via the first rubbing roll 91 and the second rubbing roll 92.

In addition, Expression (II) is a condition for both the first rubbing roll 91 and the second rubbing roll 92 to rub a region exceeding half of both the front and back surfaces of the medium S.

In particular, in Expression (II), since L1 and L2 are less than half of the transport direction length g of the medium S, it is possible to stably transport the medium S while maintaining the transport posture of the medium S without providing the guide member or the like in the transport path of the medium S in the post-processing device 25.

In addition, in the present example, in the horizontal transport path 64, a transport roll 65c for feeding to the post-processing device 25 is disposed upstream of the post-processing device 25 in the transport direction of the medium S. On the other hand, a transport roll 65d for reception from the post-processing device 25 is disposed downstream of the post-processing device 25 in the transport direction of the medium S.

Here, in order to transport the medium S at the transport velocity v0 via the transport roll 65c for feeding, the transport roll 80, and the transport roll 65d for reception, it is necessary to set an inter-roll distance among the transport roll 65c for feeding, the transport roll 80, and the transport roll 65d for reception (specifically, a distance between the circumferential centers of the contact regions of the adjacent rolls) to be shorter than the transport direction length g of the medium S.

### Control System of Post-Processing Device

In the present exemplary embodiment, as shown in FIG. 15, a control device 120 that controls the respective elements (imaging engine 22, medium transport system 23, fixing device 24, post-processing device 25, and the like) of the image forming system 20 is provided.

In the present example, in the horizontal transport path 64, a position sensor 130 as a position detection section is provided upstream of the post-processing device 25 in the transport direction of the medium S.

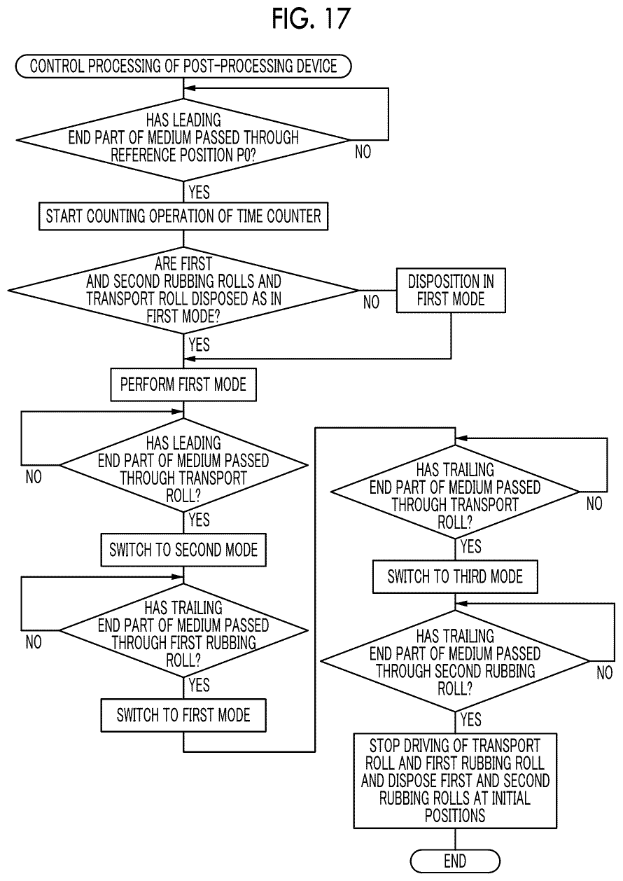

In the present example, the control device 120 is a device in which a necessary program, such as an imaging program of the image forming system 20 and a control processing program (see FIG. 17) of the post-processing device 25, is installed in advance in a memory (not shown). The control device 120 executes the imaging program by turning on a start switch (not shown), and sends out a control signal necessary for imaging processing to the imaging engine 22, the medium transport system 23, and the fixing device 24.

Further, now, it is assumed that the leading end part of the medium S that has passed through the fixing device 24 has passed through the position sensor 130. In this case, the control device 120 imports detection information from the position sensor 130 into the processor and executes the control processing program of the post-processing device 25. Then, the control device 120 sends out a control signal for nip release to the first nip release mechanism 101 and the second nip release mechanism 102. Further, the control device 120 sends out a control signal for driving to each of the drive motors 86, 96, and 98 of the transport roll 80, the first rubbing roll 91, and the second rubbing roll 92.

### Operation of Post-Processing Device

In the present example, the control device 120 executes control processing of the post-processing device 25, as shown in FIG. 17.

In FIG. 17, the control device 120 determines whether or not the leading end part of the medium S that has passed through the fixing device 24 has passed through a predetermined reference position P0. In the present example, the control device 120 determines that the leading end part of the medium S has passed through the reference position P0, based on a detection signal from the position sensor 130.

Then, the control device 120 starts a counting operation of an internal time counter and uses the counting operation for discriminating the transport position of the medium S.

### First Mode

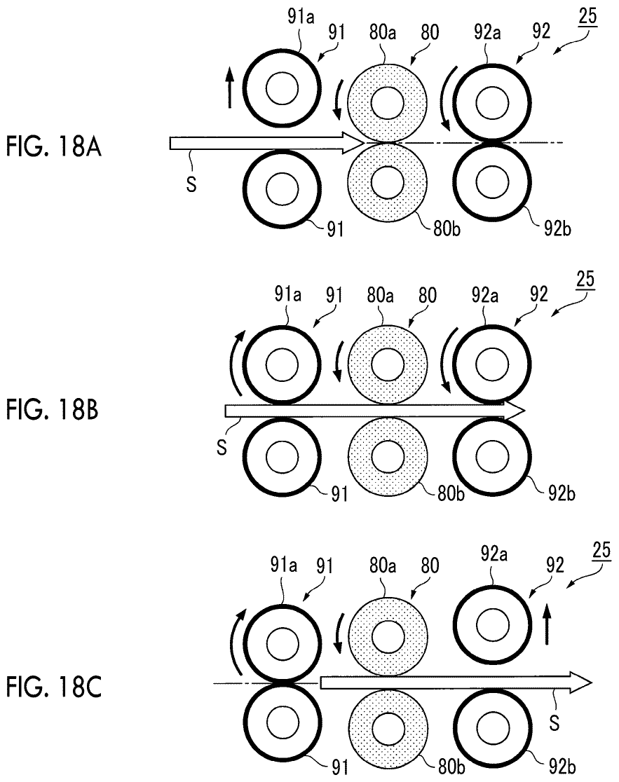

Thereafter, the control device 120 determines whether or not the first rubbing roll 91, the second rubbing roll 92, and the transport roll 80 are disposed as in a first mode. The “first mode” refers to the operation behavior shown in FIG. 18A. In this case, the first rubbing roll 91 is disposed at the release position, the transport roll 80 and the second rubbing roll 92 are disposed at the nip position. The transport roll 80 and the second rubbing roll 92 located at the nip position are driven.

In the present example, in a case in which the disposition is the disposition of the first mode, the first mode is performed. In a case in which the disposition is not the disposition in the first mode, the control device 120 disposes the first mode and then performs the first mode.

In this state, the transport roll 80 rotates idly at the predetermined transport velocity v0 at the nip position. The second rubbing roll 92 rotates idly at the velocity v2 (v2>v0) in the direction identical to the transport roll 80 at the nip position. On the other hand, the first rubbing roll 91 stops the driving at the release position and is in a standby state.

On the other hand, the medium S passes through the position sensor 130 via the transport roll 65c for feeding (see FIG. 3), and is transported into the post-processing device 25. Then, the medium S slips as it is through the first rubbing roll 91 and is directed toward the transport roll 80.

### Switching to Second Mode

Next, the control device 120 determines whether or not the leading end part of the medium S has passed through the transport roll 80. Then, in a case in which it is determined that the leading end part of the medium S has passed through the transport roll 80, the control device 120 performs switching to a second mode. The “second mode” refers to the operation behavior shown in FIG. 18B. In this case, unlike the first mode, the first rubbing roll 91 is switched to the nip position to start the driving. The transport roll 80 and the second rubbing roll 92 are the same as in the first mode.

In this state, immediately after the medium S has entered the transport roll 80, the first rubbing roll 91 nips a middle portion of the medium S in the transport direction and rotates in the direction opposite to the transport roll 80 at the velocity v1 (|v1|>v0).

Therefore, the medium S is transported in a state of being pulled in the transport direction between the first rubbing roll 91 and the transport roll 80. In this case, a relationship between the frictional force f1 between the first rubbing roll 91 and the medium S and the frictional force f0 between the transport roll 80 and the medium S is f1<f0. Therefore, the medium S is transported by the transport roll 80 at the transport velocity v0. In this state, in a case in which the first rubbing roll 91 rotates in the opposite direction at the velocity v1 in the contact region CN1, the surface of the medium S is rubbed in the direction opposite to the transport direction of the medium S. As a result, the rubbing operation using the first rubbing roll 91 is continued until the trailing end of the medium S in the transport direction passes through the first rubbing roll 91. Therefore, the rubbing region R1 of the first rubbing roll 91 is a rear half region of the medium S from the middle of the medium S in the transport direction to the trailing end of the medium S in the transport direction (see FIGS. 19A to 21B).

In the second mode, in a case in which the leading end part of the medium S reaches the second rubbing roll 92, the following behavior is exhibited. In the present example, in a case in which the medium S enters the second rubbing roll 92, the second rubbing roll 92 nips the leading end part of the medium S and rotates in the direction identical to the transport roll 80 at the velocity v2 (v2>v0).

Therefore, the medium S is transported in a state of being pulled in the transport direction between the transport roll 80 and the second rubbing roll 92. In this case, a relationship between the frictional force f2 between the second rubbing roll 92 and the medium S and the frictional force f0 between the transport roll 80 and the medium S is f2<f0. Therefore, the medium S is transported by the transport roll 80 at the transport velocity v0. In this state, in a case in which the second rubbing roll 92 rotates in the identical direction at the velocity v2 in the contact region CN2, the surface of the medium S is rubbed in the direction identical to the transport direction of the medium S. As a result, the rubbing operation using the second rubbing roll 92 is continued from the leading end part of the medium S to immediately before the medium S passes through the transport roll 80. Therefore, the rubbing region R2 of the second rubbing roll 92 is a front half region of the medium S from the leading end part of the medium S to the middle of the medium S in the transport direction (see FIGS. 19A to 21B).

### Switching to First Mode

Next, the control device 120 determines whether or not the trailing end part of the medium S has passed through the first rubbing roll 91. In this case, in a case in which the control device 120 determines that the trailing end part of the medium S has passed through the first rubbing roll 91, the control device 120 performs switching to the first mode. As a result, the first rubbing roll 91 is disposed at the release position and the driving is stopped.

This is because, in a case in which the trailing end part of the medium S passes through the first rubbing roll 91, there is no longer any medium S as the rubbing target of the first rubbing roll 91. In the present example, the switching to the first mode is performed from the viewpoint of performing the preparation for receiving the subsequent medium Sr in advance.

### Switching to Third Mode

Thereafter, the control device 120 determines whether or not the trailing end part of the medium S has passed through the transport roll 80. Then, in a case in which it is determined that the trailing end part of the medium S is immediately before passing through the transport roll 80, the control device 120 performs switching to a third mode. The “third mode” refers to the operation behavior shown in FIG. 18C. In this case, the third mode refers to the operation behavior of stopping the driving by switching the second rubbing roll 92 to the release position, unlike the first mode and the second mode. In this case, the first rubbing roll 91 and the transport roll 80 need only be the same as any one of the first mode or the second mode. FIG. 18C shows a state in which the first rubbing roll 91 is the same as in the second mode.

The third mode is a mode for well maintaining the transportability of the medium S discharged from the post-processing device 25. In a case in which the rubbing operation using the second rubbing roll 92 is continued even after the trailing end part of the medium S has passed through the transport roll 80, the medium S is discharged by the second rubbing roll 92 at the velocity v2 (v2>v0) at a point in time when the transport operation of the medium S using the transport roll 80 is no longer performed. In this case, the medium S is discharged at the velocity v2 higher than the predetermined transport velocity v0 by the second rubbing roll 92, and thus the transportability of the medium S is impaired.

### Return to Initial Position

Next, the control device 120 determines whether or not the trailing end part of the medium S has passed through the second rubbing roll 92. In the present example, in a case in which it is determined that the trailing end part of the medium S has passed through the second rubbing roll 92, the control device 120 stops the driving of the transport roll 80 and the first rubbing roll 91, and disposes the first rubbing roll 91 and the second rubbing roll 92 at the initial positions. In the present example, the initial position is selected, for example, as the disposition in the first mode (the first rubbing roll 91 is at the release position and the second rubbing roll 92 is at the nip position).

### Specific Example of Wax Rubbing Processing Using Post-Processing Device

In the present example, a distance L1 (see paragraph [0083]) between the first rubbing roll 91 and the transport roll 80 and a distance L2 (see paragraph [0083]) between the transport roll 80 and the second rubbing roll 92 may be appropriately selected such that Expression (I): L1+L2=L<g (transport direction length of medium S) and Expression (II): L1, L2<g/2 are satisfied.

Therefore, typical examples thereof include an aspect in which L1=L2, but hereinafter, Specific Example 1 and Specific Example 2 will be described.

### ⊚ Specific Example 1: Case of L1>L2

FIGS. 19A to 19E show the wax rubbing processing using the post-processing device 25 in Specific Example 1.

FIG. 19A shows a state in which the leading end part of the medium S enters the transport roll 80. In this case, since the first mode is performed, the medium S is transported by the transport roll 65c for feeding located on the inlet side of the post-processing device 25, slips through the first rubbing roll 91 located at the release position, and enters the transport roll 80.

FIG. 19B shows a state after the leading end part of the medium S has entered the transport roll 80. In this case, the second mode is performed, so that the first rubbing roll 91 is disposed at the nip position to start the driving. Then, the rubbing operation using the first rubbing roll 91 is performed from the middle of the medium S in the transport direction. In FIG. 19B, R1 indicates a rubbing region (corresponding to a hatched region in the diagonally lower left in FIG. 19B) of the first rubbing roll 91 with respect to the medium S.

FIG. 19C shows a state in which the leading end part of the medium S has entered the second rubbing roll 92. In this case, since the second mode is still being performed, the rubbing operation using the second rubbing roll 92 is started from the leading end part of the medium. The rubbing operation using the first rubbing roll 91 is continuously performed.

FIG. 19D shows a state in which the trailing end part of the medium S passes through the first rubbing roll 91. In this case, the switching to the first mode is performed, the first rubbing roll 91 is disposed at the release position, and the driving is stopped. During this period, the rubbing operation using the first rubbing roll 91 is performed from the middle of the medium S in the transport direction to the trailing end part of the medium S. In addition, the rubbing operation using the second rubbing roll 92 is performed from the leading end part of the medium S toward the downstream side of the medium S in the transport direction. In FIG. 19D, R2 indicates a rubbing region (corresponding to a hatched region in the diagonally lower right in FIG. 19D) of the second rubbing roll 92 with respect to the medium S.

FIG. 19E shows a state immediately before the trailing end part of the medium S passes through the transport roll 80. In this case, the switching to the third mode is performed, the second rubbing roll 92 is disposed at the release position, and the driving is stopped. During this period, the rubbing operation using the second rubbing roll 92 is performed from the leading end part of the medium S to the middle of the medium S in the transport direction. The rubbing operation using the second rubbing roll 92 is stopped at a stage in which the second rubbing roll 92 is disposed at the release position. In FIG. 19E, the rubbing region R2 of the second rubbing roll 92 is implemented in a range of approximately g-L2. On the other hand, the rubbing region R1 of the first rubbing roll 91 is implemented in a range of about g-L1.

In addition, in a case in which the switching to the third mode is performed, the leading end part of the medium S is nipped and transported by the transport roll 65d located on the outlet side of the post-processing device 25. Therefore, the transportability of the medium S discharged from the post-processing device 25 is well maintained.

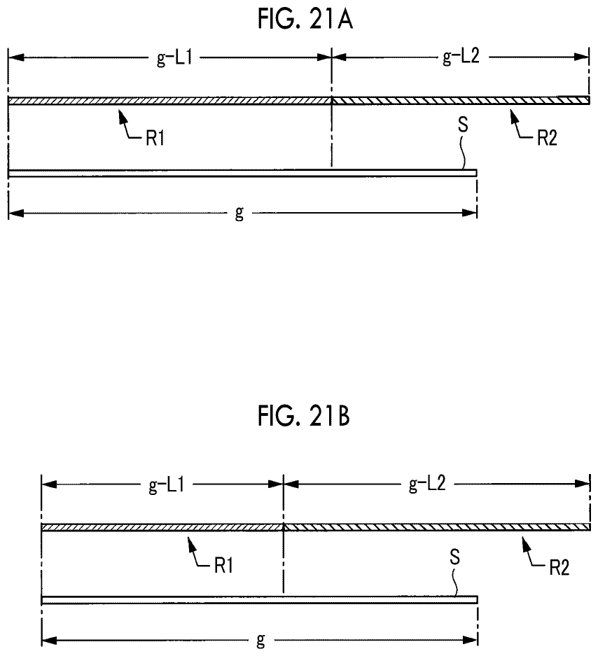

As described above, in the present example, as shown in FIG. 21A, in the wax post-processing using the post-processing device 25, both the front and back surfaces of the medium S are rubbed in the rubbing region R1 of the first rubbing roll 91 and the rubbing region R2 of the second rubbing roll 92. In the present example, since R1+R2=2g−L (g>L) is satisfied, it is understood that the wax post-processing using the post-processing device 25 is realized with the entire region of both the front and back surfaces of the medium S as the rubbing target. In addition, in the present example, the rubbing regions R1 and R2 are in a partially overlapping state in the middle portion of the transport direction of the medium S, and the relationship of R2>R1 is satisfied.

### ⊚ Specific Example 2: Case of L1<L2

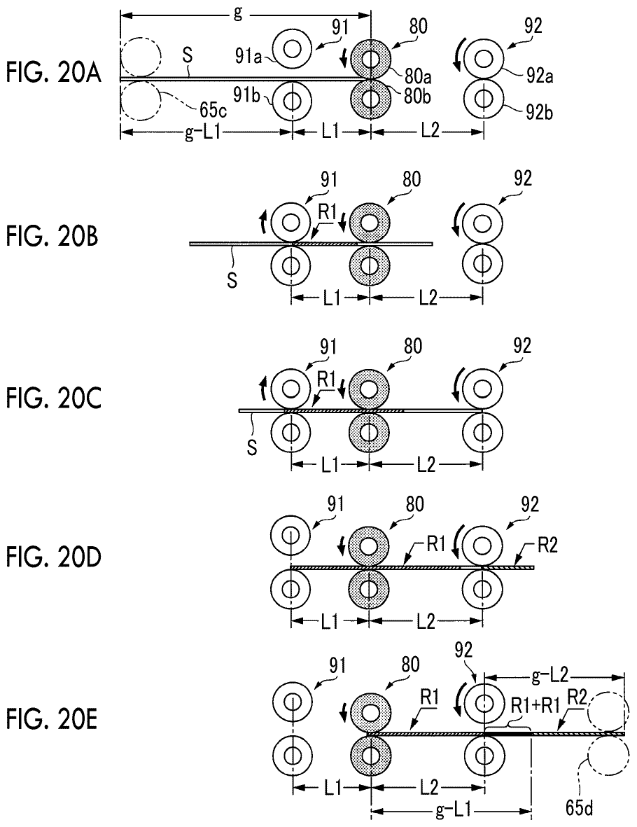

FIGS. 20A to 20E show the wax rubbing processing using the post-processing device 25 in Specific Example 2.

FIGS. 20A to 20E are substantially the same as the wax rubbing processing using the post-processing device 25 in Specific Example 1, except that a dimensional relationship between L1 and L2 is different from that in Specific Example 1.

In the present example, as shown in FIG. 21B, in the wax post-processing using the post-processing device 25, both the front and back surfaces of the medium S are rubbed in the rubbing region R1 of the first rubbing roll 91 and the rubbing region R2 of the second rubbing roll 92, as in Specific Example 1. In the present example as well, since R1+R2=2 g−L (g>L) is satisfied, it is understood that the wax post-processing using the post-processing device 25 is realized with the entire region of both the front and back surfaces of the medium S as the rubbing target. In addition, in the present example, the rubbing regions R1 and R2 are in a partially overlapping state in the middle portion of the transport direction of the medium S, and the relationship of R2<R1 is satisfied.

As described above, in the present exemplary embodiment, the wax post-processing using the post-processing device 25 is effective in that the entire region of both the front and back surfaces of the medium S can be used as the rubbing target.

In the present exemplary embodiment as well, in substantially the same manner as in Exemplary embodiments 1 and 2, it is confirmed that, before and after the post-processing using the post-processing device 25, the form of the wax W is changed from the granular mass Wa to the thin film-like layer Wb. In this case, in order to make the wax W after the post-processing less visible, for example, it is desired that the wax W is changed to the thin film-like layer Wb having the thickness tr equal to or less than 0.15 μm.

### ⊚ Modification Aspect

(1) In the present exemplary embodiment, in a case in which the first rubbing roll 91 (or second rubbing roll 92) is disposed at the release position, the driving of the plurality of rotating bodies 91a and 91b (or 92a and 92b) is stopped. However, the first rubbing roll 91 (or second rubbing roll 92) may be disposed at the release position without stopping the driving of the plurality of rotating bodies 91a and 91b (or 92a and 92b).

(2) In the present exemplary embodiment, the second mode is once switched to the first mode and then switched to the third mode, but the second mode may be switched to the third mode without passing through the first mode.

(3) In the present exemplary embodiment, the disposition of the first mode is selected as the initial position of the post-processing device 25, but the disposition of the second mode (both the first rubbing roll 91 and the second rubbing roll 92 are at the nip position) can also be selected.

(4) In the present exemplary embodiment, the aspect is adopted in which the first rubbing roll 91 is disposed upstream of the common transport roll 80 in the transport direction of the medium S and the second rubbing roll 92 is disposed downstream of the common transport roll 80 in the transport direction of the medium S, but the present invention is not limited to this, and the first rubbing roll 91 and the second rubbing roll 92 may be disposed with respect to separate transport rolls 80.

(5) In the present exemplary embodiment, the post-processing device 25 uses the sheet-like medium S as a processing target, but the present invention is not limited to this, and a continuous medium may be used as a processing target.

### ⊚ Exemplary Embodiment 4

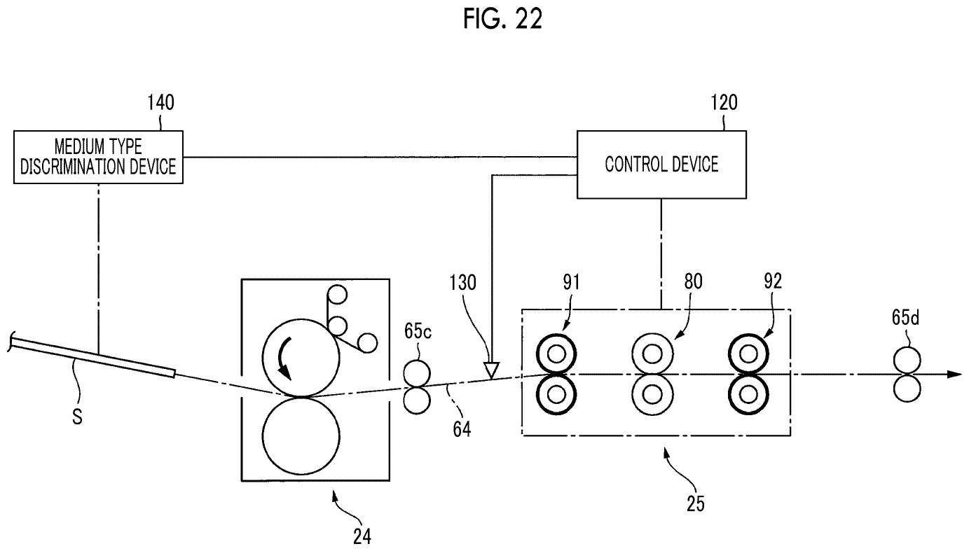

FIG. 22 is an explanatory diagram showing a major part of a post-processing device according to Exemplary Embodiment 4.

In FIG. 22, the basic configuration of the post-processing device 25 is substantially the same as the configurations in Exemplary Embodiments 1 to 3, but is different from the configurations in Exemplary Embodiments 1 to 3 in that the wax rubbing processing is selectively performed depending on the type of the medium S. The same constituent elements as the constituent elements of Exemplary Embodiment 1 will be denoted by the same reference numerals as in Exemplary Embodiment 1, and detailed description thereof will be omitted here.

In FIG. 22, reference numeral 140 is a medium type discrimination device that discriminates the type of the medium S. The medium type discrimination device 140 discriminates whether or not the medium S is a medium of a first type. Here, as the medium S of the first type, the medium of a type in which the wax transferred to the front surface or the back surface is visualized is selected from among the media S that have passed through the fixing device 24. Examples of a typical aspect of the medium S of the first type include a transparent film medium having a smooth surface.

In the present example, as the medium type discrimination device 140, a medium designated by a user of the image forming system 20 may be discriminated by a discrimination unit in the control device 120, or the type of the medium S may be discriminated by directly detecting the physical properties (smoothness (surface roughness and air permeability), electrical resistance, surface gloss, and the like) of the medium S transported by the medium transport system 23.

In the present example, the control device 120 need only determine whether or not the medium S is the medium of the first type, based on a discrimination signal from the medium type discrimination device 140. In a case in which the control device 120 determines that the medium is the first type, it is sufficient that the wax rubbing processing using the post-processing device 25 is performed. On the other hand, in a case in which the control device 120 determines that the medium is different from the medium of the first type, it is sufficient that the wax rubbing processing using the post-processing device 25 is not performed.

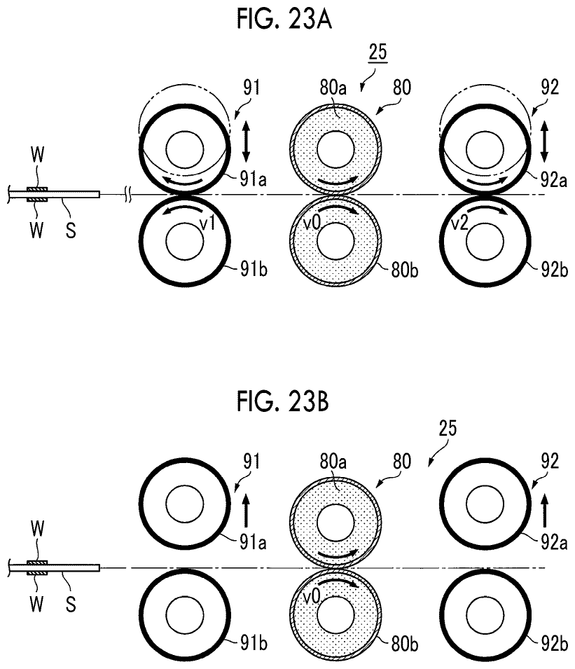

Here, in a case in which the wax rubbing processing is performed by the post-processing device 25, as shown in FIG. 23A, substantially in the same manner as in Exemplary Embodiment 1, the transport roll 80, the first rubbing roll 91, and the second rubbing roll 92 need only be controlled by the control device 120, and the rubbing operations using the first rubbing roll 91 and the second rubbing roll 92 need only be performed.

On the other hand, in a case in which the wax rubbing processing using the post-processing device 25 is not performed, as shown in FIG. 23B, it is sufficient that the control device 120 performs only the transport operation using the transport roll 80. In this case, the first rubbing roll 91 and the second rubbing roll 92 need only be disposed at the release position, to stop the driving. As a result, the medium S that does not require the wax rubbing processing is transported in the post-processing device 25 by the transport roll 80 without receiving the rubbing operations using the first rubbing roll 91 and the second rubbing roll 92.

In the present exemplary embodiment, the post-processing device 25 having substantially the same configuration as in Exemplary Embodiment 3 is adopted, but the present invention is not limited to this, and it goes without saying that, for example, the post-processing device 25 having substantially the same configuration as in Exemplary Embodiments 1 and 2 may be adopted.

### ⊚ Exemplary Embodiment 5

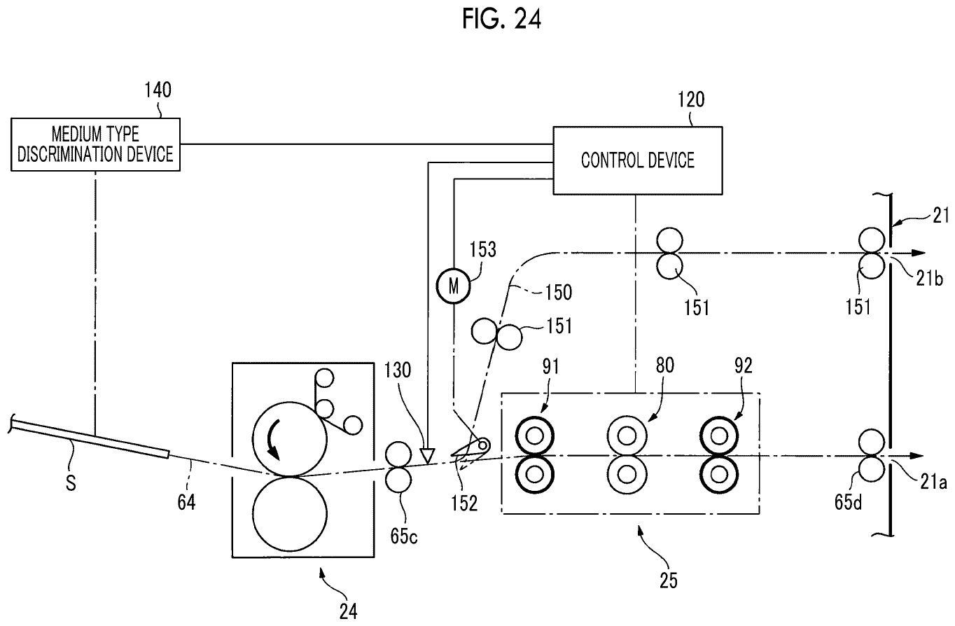

FIG. 24 is an explanatory diagram showing a major part of a post-processing device according to Exemplary Embodiment 5.

In FIG. 24, the basic configuration of the post-processing device 25 is an aspect in which the wax rubbing processing is selectively performed depending on the type of the medium S, which is substantially in the same manner as in Exemplary Embodiment 4, but is different from the configuration of Exemplary Embodiment 4. The same constituent elements as the constituent elements of Exemplary Embodiment 4 will be denoted by the same reference numerals as the reference numerals of Exemplary Embodiment 4, and detailed description thereof will be omitted here.

In FIG. 24, reference numeral 140 is a medium type discrimination device as in Exemplary Embodiment 4.

In the present example, in the horizontal transport path 64, a branch transport path 150 that branches from the horizontal transport path 64 is provided between the fixing device 24 and the post-processing device 25. The branch transport path 150 branches from the horizontal transport path 64 and then extends in a substantially horizontal direction along the side wall of the unit housing 21 toward a discharge port 21b. An appropriate number of transport rolls 151 for transporting the medium S are provided in the branch transport path 150.

In addition, a switching gate 152 as a switching section is provided at a branch point between the horizontal transport path 64 and the branch transport path 150. The switching gate 152 performs switching via a switching motor 153 to the horizontal transport path 64 or the branch transport path 150 as the transport path of the medium S.

In the present example, the control device 120 need only determine whether or not the medium S is the medium of the first type, based on a discrimination signal from the medium type discrimination device 140. In a case in which the control device 120 determines that the medium is the first type, it is sufficient that the wax rubbing processing using the post-processing device 25 is performed. On the other hand, in a case in which the control device 120 determines that the medium is different from the medium of the first type, it is sufficient that the wax rubbing processing using the post-processing device is not performed.

Here, in a case in which the wax rubbing processing using the post-processing device 25 is performed, the control device 120 need only control the switching motor 153 and cause the switching gate 152 to switch and select the transport path of the medium S to the horizontal transport path 64. As a result, the medium S is transported to the post-processing device 25, and the wax rubbing processing is performed by the post-processing device 25.

On the other hand, in a case in which the wax rubbing processing using the post-processing device 25 is not performed, the control device 120 need only control the switching motor 153 and cause the switching gate 152 to switch and select the transport path of the medium S to the branch transport path 150. As a result, the medium S is discharged from the discharge port 21b of the unit housing 21 through the branch transport path 150 without passing through the post-processing device 25.

In the present exemplary embodiment, the post-processing device 25 having substantially the same configuration as in Exemplary Embodiment 3 is adopted, but the present invention is not limited to this, and it goes without saying that, for example, the post-processing device 25 having substantially the same configuration as in Exemplary Embodiments 1 and 2 may be adopted.

### EXAMPLES

### ⊚ Example 1

In Example 1, the wax rubbing processing is performed by using the post-processing device 25 of the image forming system 20 according to Exemplary Embodiment 1.

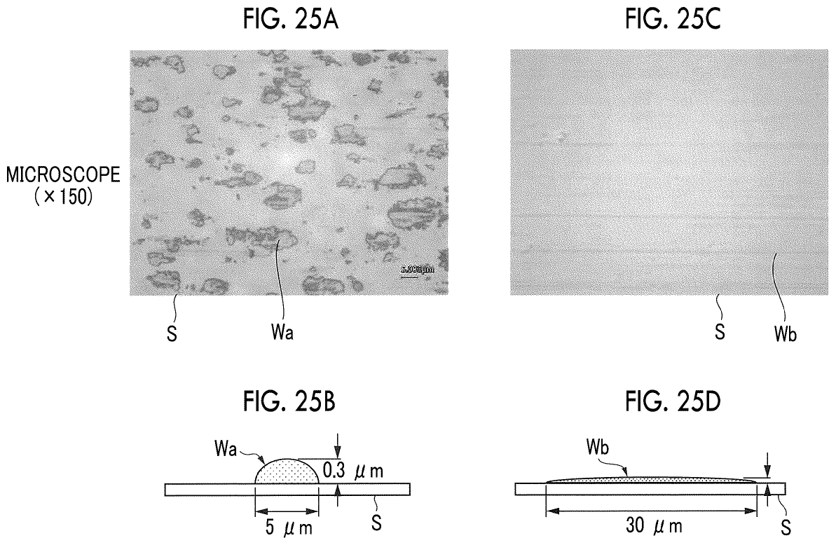

FIG. 25A shows a microscope photograph (×150 times) obtained by imaging a surface state of the medium (transparent film medium is used) that has passed through the fixing device before the post-processing using the post-processing device 25.

FIG. 25C shows a microscope photograph (×150 times) obtained by imaging a surface state of the medium (transparent film medium is used) that has passed through the fixing device after the post-processing using the post-processing device 25.

In a case of evaluating the post-processing using the post-processing device 25, a cross-sectional state of the medium S before the post-processing shown in FIG. 25A is confirmed, and a result as shown in FIG. 25B is obtained. In FIG. 25B, the wax W transferred to the medium S is confirmed in a large amount as the granular mass Wa (for example, a mass having a radius of m and a thickness of about 0.3 μm). In this case, the reflected light or the transmitted light to the medium S is scattered by the granular mass Wa, and is visualized. Such a granular mass Wa may be conspicuous as a surface contamination of the medium S, and the image formed using the toner may lead to the image defect.

On the other hand, as shown in FIG. 25C, a cross-sectional state of the medium S after the post-processing using the post-processing device 25 is confirmed, and a result as shown in FIG. 25D is obtained. In FIG. 25D, it is confirmed that the wax W transferred to the medium S is changed to the thin film-like layer Wb (for example, a layer having a thickness of about 0.1 m in a circular region having a diameter of 30 μm) that is smoothly thinly spread in a flattened manner by the rubbing processing using the post-processing device 25. In this case, in the thin film-like layer Wb, there is no scattering as in the granular mass Wa, and the wax is in a less visible state. Therefore, a case in which the wax transferred to the medium S may be manifested as surface contamination is effectively suppressed.

### ⊚ Example 2

Example 2 is to confirm the effectiveness of the rubbing processing using the post-processing device 25 by using the post-processing device 25 of the image forming system 20 according to Exemplary Embodiment 1 or 2.

In the present example, a film medium (for example, OZK-E188A manufactured by DYNIC CORPORATION) having a smooth surface is used as the medium S, and for a plurality of medium samples having different visual grades, a post-processing state with respect to the wax transfer is examined, and whether or not the wax is less visible is visually confirmed.

Here, in examining the post-processing state of the medium S, the thickness tr (wax layer thickness) of the thin film-like layer Wb of the wax is measured, and the boundary value of the thickness tr at which the wax of the medium S can be made less visible is obtained.

In the present example, as the measurement method, a method of calculating a height of the wax particles on the medium by averaging maximum heights (corresponding to maximum thicknesses) of a plurality of wax particles existing in a certain measurement region using an optical microscope is adopted. In obtaining the average of the maximum heights, the sum of the maximum heights of the wax particles in the measurement region is divided by the number of particles.

Measurement conditions are as follows.
Optical microscope: KEYENCE VK-X3000
Measurement method: laser irradiation method
Magnification: 500 times
Scan mode: laser confocal
Measurement region: 0.2 mm×0.2 mm
Measurement size: standard (1024×768)
Measurement quality setting: high accuracy
Measurement pitch setting: 0.13 μm

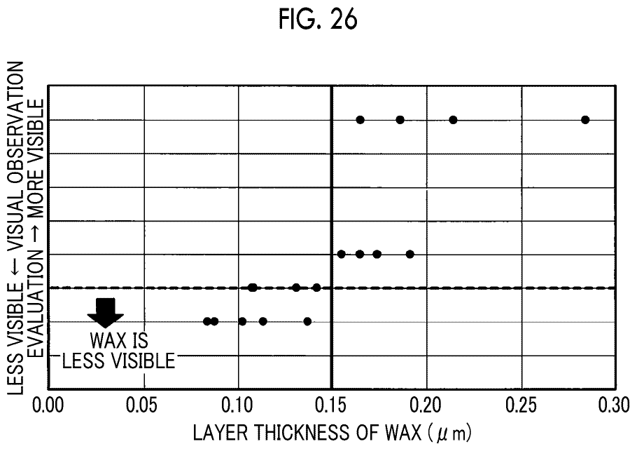

In the present example, in a case in which a correlation between the calculated average height of the wax particles (corresponding to the layer thickness of the wax) and the visual grade is graphed, a result shown in FIG. 26 is obtained.

As seen from FIG. 26, the wax is less visible in a case in which the wax layer thickness is equal to or less than 0.15 μm.

### Supplementary Note

(((1)))

A post-processing device comprising:
a transport section that transports a medium holding an image formed using an imaging material and wax and having passed through a fixing section that performs heating and pressurization to fix the image on the medium, at a predetermined transport velocity by nipping the medium; and
a rubbing section that is located upstream or downstream of the transport section in a transport direction of the medium and that rubs, in a case in which the medium transported by the transport section passes through the rubbing section, a surface of the medium such that a layer thickness of the wax held on the surface of the medium after passage is equal to or less than 0.15 μm.
   (((2)))

The post-processing device according to (((1))),
wherein the rubbing section is located upstream of the transport section in the transport direction of the medium and rubs the surface of the medium in a direction opposite to the transport direction of the medium at a velocity different from the transport velocity of the medium.
   (((3)))

The post-processing device according to (((1))),
wherein the rubbing section is located downstream of the transport section in the transport direction of the medium and rubs the surface of the medium in a direction identical to the transport direction of the medium at a velocity higher than the transport velocity of the medium.
   (((4)))

The post-processing device according to any one of (((1))) to (((3))),
wherein the rubbing section rubs both front and back surfaces of the medium.
   (((5)))

The post-processing device according to any one of (((1))) to (((4))),
wherein the transport section consists of a plurality of rotating bodies that are disposed to face each other with respect to the medium, and
the rubbing section consists of a plurality of rotating bodies that are disposed to face each other with respect to the medium and that are capable of coming into contact with and separating from each other between a contact position and a non-contact position.
   (((6)))

The post-processing device according to (((5))),
wherein a frictional force between the plurality of rotating bodies constituting the transport section and the medium is larger than a frictional force between the plurality of rotating bodies constituting the rubbing section and the medium.
   (((7)))

The post-processing device according to (((6))),
wherein the transport section and the rubbing section have an adjustment portion that adjusts contact pressures of the plurality of rotating bodies.
   (((8)))

The post-processing device according to (((1))), further comprising:
a position detection section that detects a transport position of the medium; and
a control section that controls a rubbing operation using the rubbing section based on positional information from the position detection section.
   (((9)))

The post-processing device according to (((8))),
wherein, in an aspect in which the rubbing section is located upstream of the transport section in the transport direction of the medium,
the control section disposes, immediately after a leading end of the medium in the transport direction has entered the transport section, the rubbing section at a contact position in contact with the surface of the medium to start the rubbing operation using the rubbing section.
   (((10)))

The post-processing device according to (((8))),
wherein, in an aspect in which the rubbing section is located upstream of the transport section in the transport direction of the medium,
the control section disposes, before a leading end of the medium in the transport direction reaches the rubbing section, the rubbing section at a non-contact position separated from a contact position in contact with the surface of the medium to stop the rubbing operation using the rubbing section.
   (((11)))

The post-processing device according to (((8))),
wherein, in an aspect in which the rubbing section is located downstream of the transport section in the transport direction of the medium,
the control section disposes, before a leading end of the medium in the transport direction reaches the rubbing section, the rubbing section at a contact position in contact with the surface of the medium to start the rubbing operation using the rubbing section.
   (((12)))

The post-processing device according to (((8))),
wherein, in an aspect in which the rubbing section is located downstream of the transport section in the transport direction of the medium,
the control section disposes, immediately before a trailing end of the medium in the transport direction passes through the transport section, the rubbing section at a non-contact position separated from a contact position in contact with the surface of the medium to stop the rubbing operation using the rubbing section.
   (((13)))

The post-processing device according to any one of (((1))) to (((12))), further comprising:
a discrimination section that discriminates whether or not a medium to be used is a medium of a predetermined first type; and
a selection section that selects to perform a rubbing operation using the rubbing section in a case in which the discrimination section discriminates that the medium is the first type.
   (((14)))

The post-processing device according to (((13))),
wherein the medium of the first type is a medium of a type in which the wax transferred to a front surface or a back surface is visualized.
   (((15)))

The post-processing device according to (((14))),
wherein the medium of the first type is a film medium having a smooth surface.
   (((16)))

The post-processing device according to claim any one of (((13))) to (((15))),
wherein the selection section selects not to perform the rubbing operation using the rubbing section in a case in which the discrimination section discriminates that the medium is a type other than the first type.
   (((17)))

An image forming system comprising:
an imaging section that holds an image formed using an imaging material containing wax on a medium;
a fixing section that performs heating and pressurization to fix the image formed by the imaging section on the medium; and
the post-processing device according to any one of (((1))) to (((16))) that performs post-processing on the medium having passed through the fixing section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing device comprising:
a transport section that transports a medium holding an image formed using an imaging material and wax and having passed through a fixing section that performs heating and pressurization to fix the image on the medium, at a predetermined transport velocity by nipping the medium; and
a rubbing section that is located upstream or downstream of the transport section in a transport direction of the medium and that rubs, in a case in which the medium transported by the transport section passes through the rubbing section, a surface of the medium such that a layer thickness of the wax held on the surface of the medium after passage is equal to or less than 0.15 μm.

2. The post-processing device according to claim 1,
wherein the rubbing section is located upstream of the transport section in the transport direction of the medium and rubs the surface of the medium in a direction opposite to the transport direction of the medium at a velocity different from the transport velocity of the medium.

3. The post-processing device according to claim 1,
wherein the rubbing section is located downstream of the transport section in the transport direction of the medium and rubs the surface of the medium in a direction identical to the transport direction of the medium at a velocity higher than the transport velocity of the medium.

4. The post-processing device according to claim 1,
wherein the rubbing section rubs both front and back surfaces of the medium.

5. The post-processing device according to claim 1,
wherein the transport section consists of a plurality of rotating bodies that are disposed to face each other with respect to the medium, and
the rubbing section consists of a plurality of rotating bodies that are disposed to face each other with respect to the medium and that are capable of coming into contact with and separating from each other between a contact position and a non-contact position.

6. The post-processing device according to claim 5,
wherein a frictional force between the plurality of rotating bodies constituting the transport section and the medium is larger than a frictional force between the plurality of rotating bodies constituting the rubbing section and the medium.

7. The post-processing device according to claim 6,
wherein the transport section and the rubbing section have an adjustment portion that adjusts contact pressures of the plurality of rotating bodies.

8. The post-processing device according to claim 1, further comprising:
a position detection section that detects a transport position of the medium; and
a control section that controls a rubbing operation using the rubbing section based on positional information from the position detection section.

9. The post-processing device according to claim 8,
wherein, in an aspect in which the rubbing section is located upstream of the transport section in the transport direction of the medium,
the control section disposes, immediately after a leading end of the medium in the transport direction has entered the transport section, the rubbing section at a contact position in contact with the surface of the medium to start the rubbing operation using the rubbing section.

10. The post-processing device according to claim 8,
wherein, in an aspect in which the rubbing section is located upstream of the transport section in the transport direction of the medium,
the control section disposes, before a leading end of the medium in the transport direction reaches the rubbing section, the rubbing section at a non-contact position separated from a contact position in contact with the surface of the medium to stop the rubbing operation using the rubbing section.

11. The post-processing device according to claim 8,
wherein, in an aspect in which the rubbing section is located downstream of the transport section in the transport direction of the medium,
the control section disposes, before a leading end of the medium in the transport direction reaches the rubbing section, the rubbing section at a contact position in contact with the surface of the medium to start the rubbing operation using the rubbing section.

12. The post-processing device according to claim 8,
wherein, in an aspect in which the rubbing section is located downstream of the transport section in the transport direction of the medium,
the control section disposes, immediately before a trailing end of the medium in the transport direction passes through the transport section, the rubbing section at a non-contact position separated from a contact position in contact with the surface of the medium to stop the rubbing operation using the rubbing section.

13. The post-processing device according to claim 1, further comprising:
a discrimination section that discriminates whether or not a medium to be used is a medium of a predetermined first type; and
a selection section that selects to perform a rubbing operation using the rubbing section in a case in which the discrimination section discriminates that the medium is the first type.

14. The post-processing device according to claim 13,
wherein the medium of the first type is a medium of a type in which the wax transferred to a front surface or a back surface is visualized.

15. The post-processing device according to claim 14,
wherein the medium of the first type is a film medium having a smooth surface.

16. The post-processing device according to claim 13,
wherein the selection section selects not to perform the rubbing operation using the rubbing section in a case in which the discrimination section discriminates that the medium is a type other than the first type.

17. An image forming system comprising:
an imaging section that holds an image formed using an imaging material containing wax on a medium;
a fixing section that performs heating and pressurization to fix the image formed by the imaging section on the medium; and
the post-processing device according to claim 1 that performs post-processing on the medium having passed through the fixing section.

18. An image forming system comprising:
an imaging section that holds an image formed using an imaging material containing wax on a medium;
a fixing section that performs heating and pressurization to fix the image formed by the imaging section on the medium; and
the post-processing device according to claim 2 that performs post-processing on the medium having passed through the fixing section.

19. An image forming system comprising:
an imaging section that holds an image formed using an imaging material containing wax on a medium;
a fixing section that performs heating and pressurization to fix the image formed by the imaging section on the medium; and
the post-processing device according to claim 3 that performs post-processing on the medium having passed through the fixing section.

20. An image forming system comprising:
an imaging section that holds an image formed using an imaging material containing wax on a medium;
a fixing section that performs heating and pressurization to fix the image formed by the imaging section on the medium; and
the post-processing device according to claim 4 that performs post-processing on the medium having passed through the fixing section.
